(19) United States
(12) Patent Application Publication
(10) Pub. No.: US 2023/0073188 A1
(43) Pub. Date: Mar. 9, 2023

(54) Automatic Damage Detection Database

(71) Applicant: Allstate Insurance Company, Northbrook, IL (US)

(72) Inventors: Randall M. Hanson, Lake Ozark, MO (US); Nicole M. Hildebrandt, Arlington Heights, IL (US); Anthony L. Bond, Lewisville, TX (US); Clint J. Marlow, Barrington Hills, IL (US); Ami J. Gupta, Grayslake, IL (US); Floyd M. Yager, Park Ridge, IL (US); Joy A. Thomas, Glenview, IL (US); Eric D. Huls, Chicago, IL (US)

(21) Appl. No.: 15/251,979

(22) Filed: Aug. 30, 2016

Related U.S. Application Data
(63) Continuation-in-part of application No. 14/958,512, filed on Dec. 3, 2015.
Application No. 14/958,512 is a continuation-in-part of application No. 14/561,918, filed on Dec. 5, 2014.
Application No. 14/561,918 is a continuation-in-part of application No. 14/465,475, filed on Aug. 21, 2014.
Application No. 14/465,475 is a continuation-in-part of application No. 13/458,388, filed on Apr. 27, 2012, now Pat. No. 9,424,606.
(60) Provisional application No. 62/014,942, filed on Jun. 20, 2014.
(60) Provisional application No. 61/480,207, filed on Apr. 28, 2011.

(51) Int. Cl. G06Q 40/08; G06F 17/30

(52) U.S. Cl. CPC G06Q 40/08; G06F 17/30289; G06F 17/30312

(57) ABSTRACT

Systems and methods for automatically determining damage information and publishing said damage information are provided. A notice of loss associated with a damaged item may be received. An apparatus may analyze the damaged item to determine damage information for any damage elements present on the damaged item. The damage information may be transmitted to a damage estimate server to determine a line-item cost estimate for the damaged item based on expected costs of repair for the damaged elements. The line-item cost estimate may then be presented to a repair service provider as an offer to repair the damaged item. Further, a database comprising the damage information and/or line-item cost estimate may be published to a marketplace for use by service providers.

### CROSS-REFERENCE TO RELATED APPLICATIONS

This application is a continuation-in-part of U.S. patent application Ser. No. 14/958,512 entitled “Automatic Damage Detection and Repair Assessment” and filed on Dec. 3, 2015, which is a continuation-in-part of U.S. patent application Ser. No. 14/561,918 entitled “Streamlined Claims Processing with Non-Negotiable Payment for Repair and Repair Cost Feedback Loop” and filed on Dec. 5, 2014, which is a continuation-in-part of U.S. patent application Ser. No. 14/465,475 entitled “Streamlined Claims Processing” and filed on Aug. 21, 2014, which is a continuation-in-part of U.S. patent application Ser. No. 13/458,388 entitled “Enhanced Claims Settlement” and filed on Apr. 27, 2012, which claims the benefit of U.S. Provisional Patent Application No. 61/480,207 entitled “Enhanced Claims Settlement” and filed on Apr. 28, 2011, each of which are incorporated by reference herein in their entirety. U.S. patent application Ser. No. 14/465,475 also claims the benefit of U.S. Provisional Patent Application No. 62/014,942 entitled “Streamlined Claims Processing” and filed on Jun. 20, 2014, which is also incorporated by reference herein in its entirety.

### BACKGROUND

Handling insurance claims can be a time-consuming and complex process for both the claimant and the claims processor. The claimant often starts the process with a first notice of loss to a claims processing office associated with an insurance company. Usually, a claims adjuster within the claims processing office is assigned to the case to assess the damage for which compensation is sought. The claims adjustment process can involve paperwork processing, telephone calls, and potentially face-to-face meetings between claimant and adjuster. In addition, time can elapse between a first notice of loss from the claimant and the final settlement of the claim.

### SUMMARY

The following presents a simplified summary of the present disclosure in order to provide a basic understanding of some aspects of the disclosure. This summary is not an extensive overview of the disclosure. It is not intended to identify key or critical elements or to delineate the scope of the claimed subject matter. The following summary merely presents some concepts of the disclosure in a simplified form as a prelude to the more detailed description provided below.

A first aspect described herein provides systems and/or methods for automatically detecting damage and assessing needed repairs using an enhanced claim processing server. An enhanced claims processing server may receive a notice of loss associated with a damaged item as well as damage information describing damage that has occurred to the damaged item. Repair cost data may be retrieved from a repair cost data store based on the damage information received. A repair cost generator may configure a repair cost model based on the damage information received and the repair cost data retrieved. The repair cost generator may utilize the repair cost model to generate a repair cost for repairing the damaged item, and a non-negotiable payment amount may be selected based on the repair cost generated. A work order generator may generate a work order that includes at least some of the damage information received and the non-negotiable payment amount. The enhanced claims processing server may transmit the work order to a repair service provider system that is associated with a repair service provider that has accepted the terms of the work order. The enhanced claims processing system may, in turn, receive from the repair service provider system feedback that indicates an actual cost to repair the damaged item. The enhanced claims processing server may then update the repair cost data based on the feedback received.

A second aspect described herein provides systems and/or methods for automatically detecting damage and assessing needed repairs using a feedback interface. A damage information data store may store damage information describing damage that has occurred to a damaged item. A repair cost data store may store repair cost data describing the cost to repair one or more items. A repair cost generator may be configured to configure a repair cost model based on at least some of the damage information and at least some of the repair cost data. The repair cost generator may also be configured to generate, using the repair cost model, a repair cost amount for repairing the damaged item. A work order may indicate a non-negotiable payment amount that is selected based on the repair cost amount generated and include at least some of the damage information. A feedback interface may be configured to receive feedback from a repair service provider system associated with a repair service provider that has accepted the terms of the work order. The feedback may indicate the actual cost to repair the damaged item. The feedback interface may also be configured to modify the repair cost data based on the feedback received.

A third aspect described herein provides systems and/or methods for automatically detecting damage and assessing needed repairs using a damage estimate processing server. An enhanced claims processing server may receive a first notice of loss from a claimant. An enhanced claims processing apparatus that is configured to determine information regarding different damage elements for the damaged item. An estimate processing server may then compare entries in the database to the information regarding the damage elements in order to generate a line-item cost estimate. The line-item cost estimate may then be submitted to a repair service provider as an expected estimated cost for repairing the damaged item. A database comprising the damage information and/or line-item cost estimate may be created. The database may be published to a marketplace for use by service providers. In some instances, information may be provided to a repair service provider in the form of a damage summary.

The details of these and other embodiments of the disclosure are set forth in the accompanying drawings and description below. Other features and advantages of aspects of the disclosure will be apparent from the description, drawings, and claims.

### BRIEF DESCRIPTION OF THE DRAWINGS

The present disclosure is illustrated by way of example and is not limited in the accompanying figures in which like reference numerals indicate similar elements.

FIG. 1 is a block diagram of an operating environment in which various aspects of the disclosure may be implemented.

FIG. 2 is a block diagram of workstations and servers that may be used to implement the processes and functions of certain aspects of the present disclosure.

FIG. 3 is a block diagram of a workflow for using an enhanced claims processing server in accordance with at least one aspect of the present disclosure.

FIG. 4 is a block diagram of an example of an implementation of an enhanced claims processing apparatus in accordance with at least one aspect of the present disclosure.

FIG. 5 is a block diagram of the feedback loop provided by the enhanced claims processing system in accordance with at least one aspect of the present disclosure.

FIG. 6 is a block diagram of an example of an implementation of an enhanced claims processing system in accordance with at least one aspect of the present disclosure.

FIG. 7 is a flowchart of example method steps for using an enhanced claims processing system with a feedback loop in accordance with at least one aspect of the present disclosure.

FIG. 8 is a block diagram of an example of an implementation of a damage information collection device in accordance with at least one aspect of the present disclosure.

FIG. 9 is a block diagram of another example of an enhanced claims processing system in accordance with at least one aspect of the present disclosure.

FIG. 10 is a flowchart of example method steps for collecting damage information related to a damaged item in accordance with at least one aspect of the present disclosure.

FIG. 11 is a flowchart of example method steps for using a damage estimate processing server in accordance with at least one aspect of the present disclosure.

FIG. 12 is an example line-item cost estimate in accordance with at least one aspect of the disclosure.

FIG. 13 is a flowchart of example method steps for determining a value associated with a predicted future damage estimate for a vehicle.

FIG. 14 is an example description in a damage summary in accordance with at least one aspect of the disclosure.

FIG. 15 is an example vehicle panel report in a damage summary in accordance with at least one aspect of the disclosure.

FIG. 16 is an example dent overview in a damage summary in accordance with at least one aspect of the disclosure.

### DETAILED DESCRIPTION

U.S. patent application Ser. No. 14/561,918—which the present application claims priority to as a continuation-in-part—discusses systems and methods for generating a non-negotiable payment amount to repair damage to an item based on feedback received from repair service providers indicating the actual cost to repair damaged items. That application notes that the enhanced claims settlement server may utilize such information to generate a more accurate payment amount for future work orders. The present disclosure provides systems and methods for automatically detecting damage and assessing needed repairs using an enhanced claims processing apparatus. The damage information may be used to generate a detailed line-item cost estimate describing one or more damage elements for a damaged item.

The feedback received from the repair service providers is added to a pool of actual repair cost data. A repair cost generator configures a repair cost model with damage information received from a claimant and actual repair cost data. The repair cost generator utilizes the repair cost model to generate a repair cost amount representing the cost to repair the damaged item. The repair cost amount may be used to select a non-negotiable payment amount an insurance company pays to a repair service provider to repair the damage to the item. Repairing an item, as used in this description, includes: replacing the damaged item with a new item, replacing a portion of the damaged item, such as a part or component of the item, with a new portion (e.g., a new part or a new component); restoring the damaged item to the condition it was in before the damage occurred; and restoring a portion of the damaged item (e.g., a part or component) to the condition that portion was in before the damage occurred. Accordingly, the feedback received from the repair service providers may include information related to the methodology applied to determine whether the item or a portion of the item should be replaced versus restored. The feedback received from the repair service providers may also include information related to the cost of individual parts replaced at the item as well as information related to the cost of labor when replacing or restoring the item.

A work order that details the damage to the item and the non-negotiable payment amount may be transmitted to various repair service providers. The terms of the work order may also require the repair service provider to provide the insurance company feedback identifying the actual cost to repair the damage to the item. The repair service provider that agrees to the terms of the work order may then repair (e.g., replace or restore) the damaged item for the claimant and provide feedback to the insurance company that indicates the actual repair cost. The insurance company may update the pool of actual repair cost data based on the feedback received. For example, the pool of repair cost data may be updated to identify the difference between the repair cost amount initially generated by the repair cost generator and the actual repair cost indicated by the repair service provider. Accordingly a subsequent repair costs amount generated will be improved as a result of the updated actual repair cost data. Due to the actual repair cost data received as feedback, subsequent repair cost amounts generated will more likely be closer to their respective actual repair costs. The repair costs generated by the repair cost generator may continue to improve as more and more feedback is received from the repair service providers.

This iterative process thus corresponds to a feedback loop in which the input to the repair cost model—the actual repair cost data—is continuously updated based on feedback corresponding to the output of the repair cost model—the repair cost amount. Over time, the difference between the repair cost generated by the repair cost generator and the actual repair cost should tend toward zero, or at least toward a difference an insurance company may decide is negligible. As a result, the need to generate repair cost estimates is advantageously eliminated. An insurance company may select a non-negotiable payment amount based on the repair cost generated. In some example implementations, the non-negotiable payment amount may equal the repair cost generated. In other example implementations, the non-negotiable payment amount may include a bonus (e.g., x% of the repair cost generated, a fixed bonus amount, etc.) in order to incentivize repair service providers to accept the non-negotiable payment amount, provide feedback regarding the actual repair cost, and so forth.

The non-negotiable payment amount and repair cost generated are distinguished from a repair estimate in that the repair service provider will not receive any additional remuneration for repairing the damaged item if the actual repair cost exceeds the non-negotiable payment amount or repair cost generated. Although the non-negotiable payment amounts may be lower than the actual repair costs initially, the non-negotiable payments amounts will adjust over time to be closer to the actual cost of repair as more and more feedback is received from the repair service providers and used to improve the pool of actual repair cost data utilized by the repair cost model when generating repair cost amounts. Furthermore, any initial profit losses may be offset by, e.g., the non-negotiable payment amounts paid to the repair service providers that exceed the actual costs to repair damaged items, the monetary incentives offered for accepting the non-negotiable payment amount and participating in the feedback process, as well as savings resulting from avoiding the costs associated with communicating and renegotiating revised repair estimates. Furthermore insurance companies may afford repair service providers a preferred status by agreeing to participate in the feedback process, and the repair service providers may experience an increased volume of business as a result. Moreover, repair service providers may cultivate more customer loyalty via a convenient and hassle-free repair process that advantageously avoids the possibility of higher bills after the repair is complete. Additional advantages will be appreciated with the benefit of the additional disclosures described in further detail below.

In accordance with various aspects of the disclosure, methods, computer-readable media, and apparatuses are disclosed for automatically detecting damage and assessing needed repairs. In certain aspects, an enhanced claims processing server manages a claims processing procedure from an initial notice of loss to transmittal of a work order to a repair service provider that repairs a damaged item.

The automated process may utilize various hardware components (e.g., processors, communication servers, memory devices, sensors, etc.) and related computer algorithms to examine an insured item after a claim has been filed for that item and to generate a work order that includes information describing the damage to the item and a non-negotiable payment for the repair service provider that repairs the damaged item.

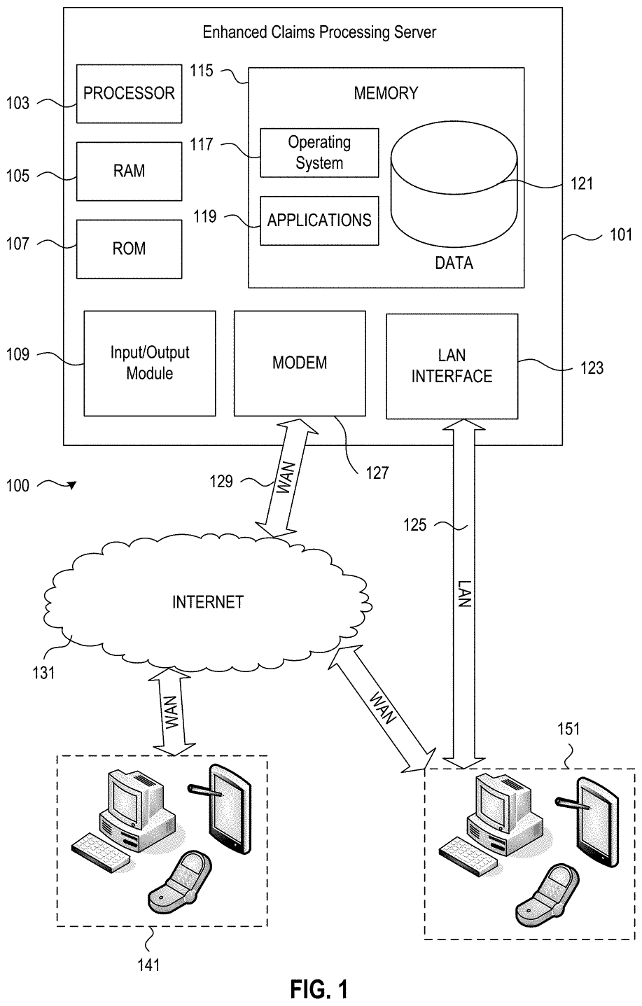

FIG. 1 illustrates a block diagram of an enhanced claims processing server 101 in communication system 100 that may be used according to an illustrative embodiment of the disclosure. Enhanced claims processing server 101 may have a processor 103 for controlling overall operation of the enhanced claims processing server 101 and its associated components, including RAM 105, ROM 107, input/output module 109, and memory 115.

Input/output module 109 may include a microphone, keypad, touch screen, and/or stylus through which a user of enhanced claims processing server 101 may provide input, and it may also include one or more speakers for providing audio output and a video display device for providing textual, audiovisual, and/or graphical output. Software may be stored within memory 115 to provide instructions to processor 103 for enabling enhanced claims processing server 101 to perform various functions. For example, memory 115 may store software used by the enhanced claims processing server 101, such as an operating system 117, application programs 119, and an associated database 121. Processor 103 and its associated components may allow the enhanced claims processing server 101 to run a series of computer-readable instructions to generate a repair cost amount for repairing the damage to the damaged item. In addition, processor 103 may determine an approved list of vendors for repairing the damaged item. Processor 103 may also schedule and accept appointments with vendors that may aid in repairing the damaged item.

The enhanced claims processing server 101 may operate in a networked environment supporting connections to one or more remote computers, such as terminals 141 and 151. The terminals 141 and 151 may be personal computers or servers that include many or all of the elements described above relative to the enhanced claims processing server 101. Also, terminal 141 and/or 151 may be sensors such as cameras and other detectors that allow damage related to an insured item for which a claim has been filed to be assessed. The network connections depicted in FIG. 1 include a local area network (LAN) 125 and a wide area network (WAN) 129, but may also include other networks. When used in a LAN networking environment, the enhanced claims processing server 101 is connected to the LAN 125 through a network interface or adapter 123. When used in a WAN networking environment, the enhanced claims processing server 101 may include a modem 127 or other means for establishing communications over the WAN 129, such as the Internet 131. It will be appreciated that the network connections shown are illustrative and other means of establishing a communications link between the computers may be used. Protocols such as TCP/IP, Ethernet, FTP, HTTP and the like may be selectively employed for network communications.

Additionally, one or more application programs 119 used by the enhanced claims processing server 101 according to an illustrative embodiment of the disclosure may include computer executable instructions for invoking functionality related to processing an insurance claim quickly and accurately (e.g., seconds or minutes), generating a repair cost amount for repairing damage to an item, creating work orders, transmitting work orders to repair service providers, receiving feedback from repair service providers, and updating a pool of actual repair cost data based on the feedback received. In one embodiment, aspects of the claim processing procedure discussed herein may occur in ten minutes or less.

Enhanced claims processing server 101 and/or terminals 141 or 151 may also be mobile and/or portable terminals (e.g., mobile cellular telephones, tablet computing devices, etc.) including various other components, such as a battery, speaker, and antennas (not shown). In this regard, enhanced claims processing server 101 may be a handheld or otherwise portable device that may be used to scan and process an insured item from all relevant angles.

The enhanced claims processing server 101 is thus a special-purpose computing device programmed with instructions that, when executed, perform functions associated with receiving damage information from claimants, generating repair cost amounts, creating work orders, and receiving feedback from repair service providers. Although only a single enhanced claims processing server 101 is shown in FIG. 1, other example implementations may include multiple special-purpose computing devices that are interconnected with one another and programmed with instructions to respectively perform the functionality identified above. Such special-purpose computing devices may be, for example, application servers programmed to perform those particular functions.

The disclosure may be described in the context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including non-transitory memory storage devices, such as a hard disk, random access memory (RAM), and read only memory (ROM).

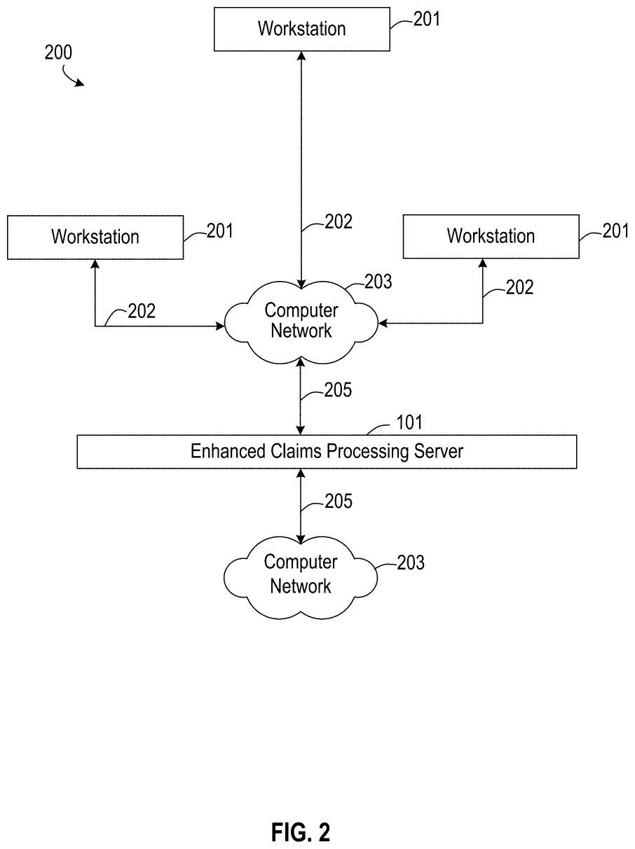

Referring to FIG. 2, a system 200 for implementing methods according to the present disclosure is shown. As illustrated, system 200 may include one or more workstations/servers 201. Workstations 201 may be local or remote, and are connected by one or more communications links 202 to computer network 203 that are linked via communications links 205 to enhanced claims settlement server 101. In certain embodiments, workstations 201 may run different algorithms used by enhanced claims processing server 101 for processing a claim submitted by a claimant, or, in other embodiments, workstations 201 may be different types of sensors that provide information to enhanced claims processing server 101 for assessing damage to an insured item for which a claim has been filed. In system 200, enhanced claims processing server 101 may be any suitable server, processor, computer, or data processing device, or combination of the same specially configured to carry out aspects of the disclosure.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and enhanced claims processing server 101, such as network links, dial-up links, wireless links, hard-wired links, etc.

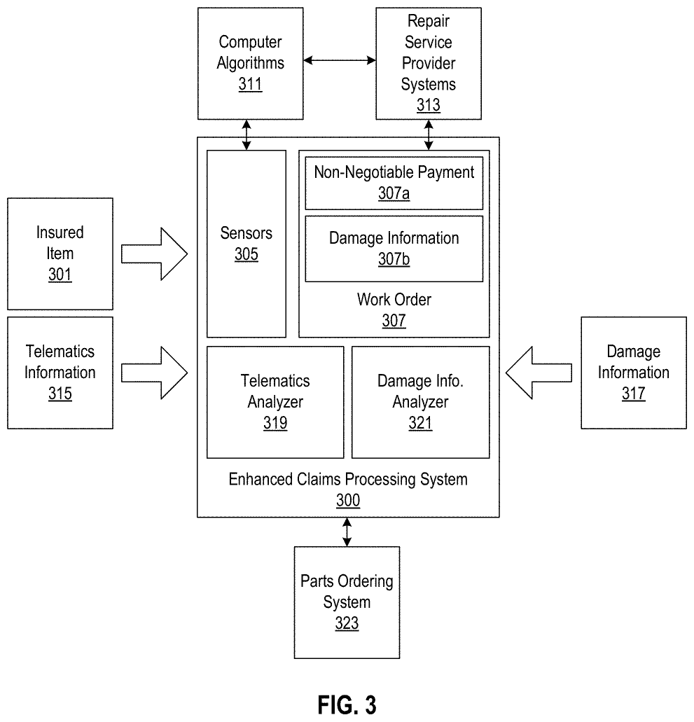

FIG. 3 is a block diagram of a workflow for using an enhanced claims processing server in accordance with at least one aspect of the present disclosure. An enhanced claims processing system 300 may include an enhanced claims processing server (such as enhanced claims processing server 101). The enhanced claims processing server 300 may carry out claims processing upon receipt of a first notification of loss (FNOL) associated with an insured item 301. The notification may be an automated notification of an accident from a telematics device, smart phone, and/or other device to enhanced claims processing system 300. In certain embodiments, if the accident is associated with a vehicle (e.g., car, truck, boat, etc.) the telematics device and/or smart phone may include an impact sensor that automatically transmits a notification of the accident involving the vehicle to enhanced claims processing system 300 when certain impact parameters are detected. Additional information such as speed, braking, or acceleration for the time period immediately preceding and immediately subsequent to the accident, as well as vehicle identifying information or insured information also may be transmitted by the telematics device and/or smart phone to the enhanced claims processing system 300. The vehicle identifying information may include license plate number, vehicle identification number, and/or vehicle make/model.

In other embodiments, claim processing may be initiated by the swipe of an insurance card or card including identification information (such as a credit card) through a sensor or card reader 305 of enhanced claims processing system 300. The insurance card or other card including identification information may include information related to the identity of the claimant (e.g., name, date of birth, terms of active insurance policies, etc.). In other embodiments, the claim processing procedure may be initiated by driving to a predetermined location associated with claims processing system 300 and having a license plate and/or vehicle identification number (VIN) read by a processor (such as processor 103), e.g., when the insured item 301 is a vehicle.

In certain aspects, the claim processing procedure may use one or more sensors 305 that are a part of or in communication with enhanced claims processing system 300 to assess damage associated with insured item 301. The sensors 305 may function simultaneously or sequentially (e.g., insured item 301 may be moved from one sensor station to another) to gather data about damage related to item 301.

The sensors 305 that are a part of enhanced claims processing system 300 may include various types of cameras (e.g., movable cameras, etc.) for taking optical digital images and/or other computing/mechanical devices (such as device 201) that may make laser and/or tactile measurements (e.g., for understanding the depth of damage to insured item 301). The sensors 305 may also measure the interaction of pressure (e.g., sound) waves or X-rays on the insured item 301 to analyze damage to the insured item. In yet other embodiments, various types of imaging technologies may be used to analyze the insured item 301. For instance, magnetic resonance imaging (MRI), infrared imaging, 3D imaging technologies (e.g., holographic imaging, etc.), and/or various types of tomography may be used to image insured item 301. The sensors 305 may also sense fluids such as transmission fluids, brake fluids, engine oil, etc. leaking from insured item 301. In other embodiments, sensors 305 may sense various aspects of tires that are a part of insured item 301 (e.g., when insured item 301 is a vehicle). For instance, sensors 305 may indicate that a frame associated with a body or a rim associated with a tire of insured item 301 is bent. Using sensors 305, server 101 may create a digital map showing the damage to insured item 301.

When the insured item 301 is a vehicle, a sensor 305 of the enhanced claims processing system 300 may also dock with an on-board diagnostic (OBD) or OBD-II system that may be a part of the vehicle's electronics system. The information recorded by the OBD and/or OBD-II system may include coolant temperature, engine RPM, vehicle speed, timing advance, throttle position, and the oxygen sensor, among other things. The OBD/OBD-II system or other system may also be used by enhanced claims processing system 300 to check the mileage in a vehicle for underwriting and/or pricing purposes. Some or all of this information may be used by enhanced claims processing system 300 to evaluate any damage to insured item 301.

In addition to gathering information through various sensors, the enhanced claims processing system 300 may also include a computer interface for a claimant to input information and/or answer questions (e.g., an automated questionnaire, etc.) around prior damage, liability, particulars of an accident, etc.

In certain aspects, enhanced claims processing system 300 may be configured to detect fraudulent claims. For instance, the automated questionnaire discussed above may also ask about an accident associated with the claim. The answers to the questions regarding the accident may be compared to the actual damage or sensor or OBDII readings associated with insured item 301. If enhanced claims processing system 300 determines that there are discrepancies between the actual damage or sensor or OBDII readings associated with insured item 301 as assessed by sensors 305 and a description of the damage provided in the answers to the automated questionnaire, then enhanced claims processing system 300 may notify a claims adjuster to intervene or take other action such as to terminate the claim. Also, if insured item 301 is a vehicle, enhanced claims processing system 300 may compare particulars about the vehicle (e.g., make, model, year of manufacture, VIN, etc.) to previously obtained vehicle information (e.g., stored in a memory associated with the enhanced claims processing system 300 and/or on file with an entity managing the system) for detecting fraud. Further, if after further analysis, the number of false positives for detecting fraud is beyond a predetermined threshold, the algorithm and/or questions used to detect fraud may be adjusted accordingly.

As another example, enhanced claims processing system 300 may be able to determine the speed of the insured item 301 (e.g., a vehicle) when an accident occurs. The speed determined by enhanced claims processing system 300 may be compared with the speed indicated by a claimant in the questionnaire. Finally, the enhanced claims processing system 300 may also be able to determine the number of people and the positions of each individual in the insured item 301 (e.g., a vehicle) when an accident occurs. This information may also be compared with the corresponding descriptions indicated by a claimant in the questionnaire.

In other aspects, enhanced claims processing system 300 may be able to interface with other databases/systems. For instance, enhanced claims processing system 300 may interface with meteorological databases to retrieve the weather conditions at the time of an accident associated with insured item 301. Enhanced claims processing system 300 may also interface with law enforcement databases to retrieve police reports of an accident associated with insured item 301 or with medical records or other databases related to people involved in an accident associated with the insured item 301.

In some implementations, a claims adjuster may view the insured item 301 through a video feed, and enhanced claims processing system 300 may manipulate sensors 305 (e.g., cameras, etc.) to capture a desired view. For instance, the enhanced claims processing system 300 may allow the claims adjuster to communicate via an electronic interface that instructs the system to move sensors 305 to a given angle. Alternatively or in addition, insured item 301 may be directly manipulated by sensors 305 (e.g., mechanical arms, etc.) to allow the claims adjuster to examine a desired view of the insured item 301. For instance, the claims adjuster may instruct the enhanced claims processing system 300 to move robotic arms or lifts that are able to position the insured item 301, allowing the claims adjuster to view a desired portion of the insured item.

As mentioned above, enhanced claims processing system 300 may generate holograms (e.g., based on magnetic resonance imaging (Mill) or other techniques using predictive computer-aided design (CAD)-type technologies, etc.) for allowing claims adjusters and other individuals to view the insured item 301. The holograms may represent three-dimensional images of insured item 301 and may allow individuals to view the exterior of insured item 301 as well as features internal to insured item 301. For instance, a hologram may allow the different components comprising a vehicle's engine to be viewed and analyzed in ways that would not be feasible with traditional imaging modalities.

In some aspects, computer algorithms 311 which may be used in determining damage may be based on specifications and/or tolerances data related to a manufacturer of insured item 301. The computer algorithms 311, which may be stored in a memory (such as memory 115) of the enhanced claims processing system 300, may also direct the enhanced claims processing system to automatically delete any photos non-relevant to damage of/data related to insured item 301 based on a comparison of the photos/data to manufacturer specifications/tolerances.

Once the insured item 301 has been adequately analyzed by sensors 305, enhanced claims processing system 300 may then generate a work order 307. In certain aspects, enhanced claims processing system 300 may automatically generate the work order 307. The work order 307 may include a non-negotiable payment 307a for repairing the damage to insured item 301 and damage information 307b which may include a description of the damage and a list of parts and part vendors for repairing the insured item 301. In addition to or alternatively, if the owner of insured item 301 is to be provided compensation for loss/damage to insured item 301, enhanced claims settlement server 101 may generate a payment card (e.g., a prepayment card) that may be used by the owner of insured item 301. The work order 307 may also be provided to the claimant as a record of the damage detected and the cost to repair the damage. The work order may also include a listing of the area, components, or parts of the item that need to be repaired or replaced.

In another aspect of the disclosure, the work order 307 may stipulate various terms of the settlement, including an agreement that the repair service provider will only receive the non-negotiable payment amount as remuneration for repairing the damage. The work order 307 may also stipulate that the repair service provider will provide feedback indicating the actual cost to repair the damage to the insured item 301. The work order may also include discounts provided to the claimant for errors on the part of enhanced claims processing system 300. For instance, the work order 307 may provide for a predetermined discount (e.g., 10% off) for any out-of-pocket expense of the claimant associated with repairing the insured item 301 if the enhanced claims processing system 300 does not detect all of the damage to the insured item (e.g., hidden damage). Moreover, once the work order 307 has been generated by enhanced claims processing system 300, the information in the work order may be transmitted to a repair service provider system as well as to a claimant computing device.

Once the data/photos related to insured item 301 are generated by various sensors 305 and/or once the claim settlement file 307 is generated by enhanced claims settlement server 101, the enhanced claims processing system 300 may provide the work order 307 and/or data/photos to a repair service provider system 313. The enhanced claims processing system 300 may also initiate payment of the non-negotiable payment 307a to the repair service provider that has accepted the terms of the work order 307.

In other aspects, enhanced claims processing system 300 may automatically apply a deductible amount to the work order 307. In addition, enhanced claims processing system 300 may also automatically generate cross-sell material (e.g., other products/services offered by the entity managing enhanced claims processing system 300) for review while a claimant waits for a work order 307 to be generated. For instance, if the entity managing enhanced claims processing system 300 is an insurance company, the enhanced claims processing system 300 may generate information about other types of insurance products offered by the insurance company while the claimant is waiting for claim processing. In certain aspects, aspects of the claims processing procedure may be highly automated and, therefore, completed in a short amount of time (e.g., seconds, minutes, etc.).

As noted above, a telematics device may provide telematics information 315 to the enhanced claims processing system 300. As described in further detail below, a damage collection device may similarly provide damage information 317 to the enhanced claims processing system 300. The enhanced claims processing system 300, in this example, includes a telematics analyzer 319 configured to analyze the telematics information 315 received as well as a damage information analyzer 321 configured to analyze the damage information 317 received. Analysis of the telematics information 315 may also constitute a first notice of loss where the telematics analyzer 319 determines that the insured item 301 has been damaged based on the telematics information received. Analysis of the telematics information 315 and the damage information 317 may also indicate one or more parts of the insured item 301 that will need to be obtained in order to repair the insured item. The telematics analyzer 319 and the damage information analyzer may be configured to generate, independently of each other or in conjunction with each other, a list of parts needed to repair the insured item 301.

The enhanced claims processing system may query one or more repair service provider systems 313 to determine whether a repair service provider has the parts needed to repair the insured item 301 (or at least ready access to the parts needed to repair the insured item) and has the capacity to promptly repair the insured item within a reasonable timeframe (e.g., around the average amount of time needed to conduct repairs of the type needed). The enhanced claims processing system 300 may also be in signal communication with a parts ordering system 323 and transmit a parts order to the parts ordering system. The parts order may include the list of parts identified by the telematics analyzer 319 or the damage information analyzer 321. If a repair service provider has been selected to repair the insured item 301, then the enhanced claims processing system 300 may identify that repair service provider as the recipient for the delivery of the parts order. If a repair service provider has not yet been selected, then the enhanced claims processing system 300 may identify a local distribution center as the recipient for the delivery of the parts order. The local distribution center may be one that is located in a geographic region within which the claimant will have the insured item 301 repaired. In either case, the enhanced claims processing system 300 reduces repair wait times by obtaining or requesting the parts needed to repair the damaged item shortly after receipt of the first notice of loss. In this way, the parts may have already been delivered to or may already be in transit to the repair service provider when the claimant delivers the insured item 301 to the repair service provider for repair.

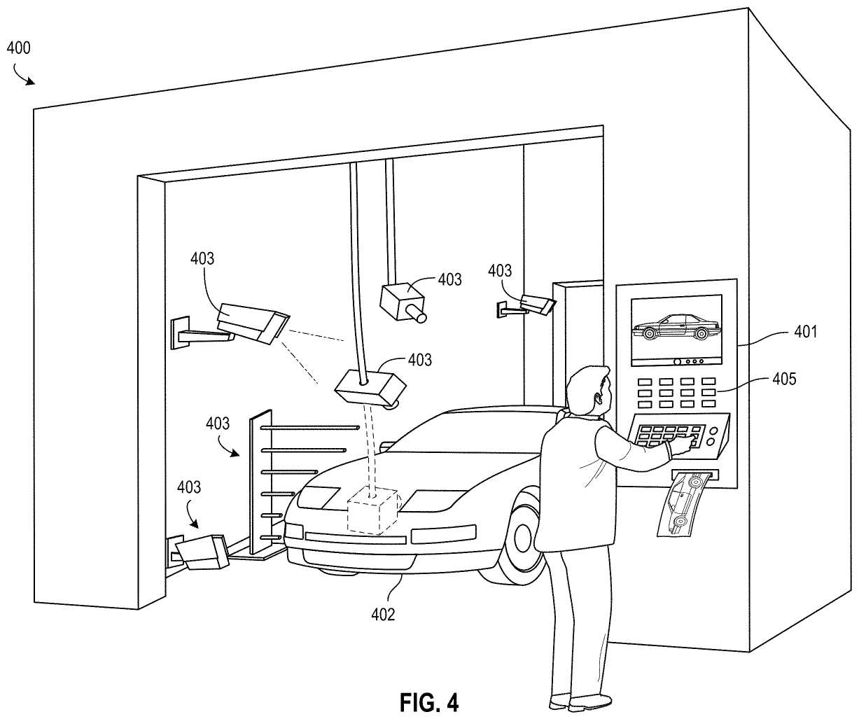

FIG. 4 illustrates an enhanced claims processing apparatus 400 employing an enhanced claims processing server 401 in accordance with various aspects of the present disclosure. The enhanced claims processing server 401 may be the same as or at least similar to the enhanced claims processing server 101 described above with reference to FIG. 1. Like the enhanced claims processing server 101, the enhanced claims processing server 401 is a special-purpose computing device programmed with instructions to perform functionality described herein. The enhanced claims processing server 401, in this example, may be used when the insured item is a vehicle 402. In FIG. 4, an owner of vehicle 402 may file a claim for damage to vehicle 402. The owner may notify enhanced claims processing server 401 through any of the various modalities mentioned above, including automatic notification via a telematics device, through manual notification, and/or by simply driving to a predetermined location associated with enhanced claims processing server 401. Vehicle 402 may be analyzed by various sensors 403 (e.g., cameras, tactile sensors, ultrasonic sensors, electromagnetic sensors, etc.), which may be a part of enhanced claims processing apparatus 400, to determine damage caused to vehicle 402 so that a work order (such as work order 307) may be generated by enhanced claims processing server 401. Enhanced claims processing server 401 may also include a user interface 405 through which a user may perform various activities. For instance, a user may swipe an insurance card associated with vehicle 402 through user interface 405. In addition, a user may, through user interface 405, view/print photos, data, and other information generated by enhanced claims processing server 101.

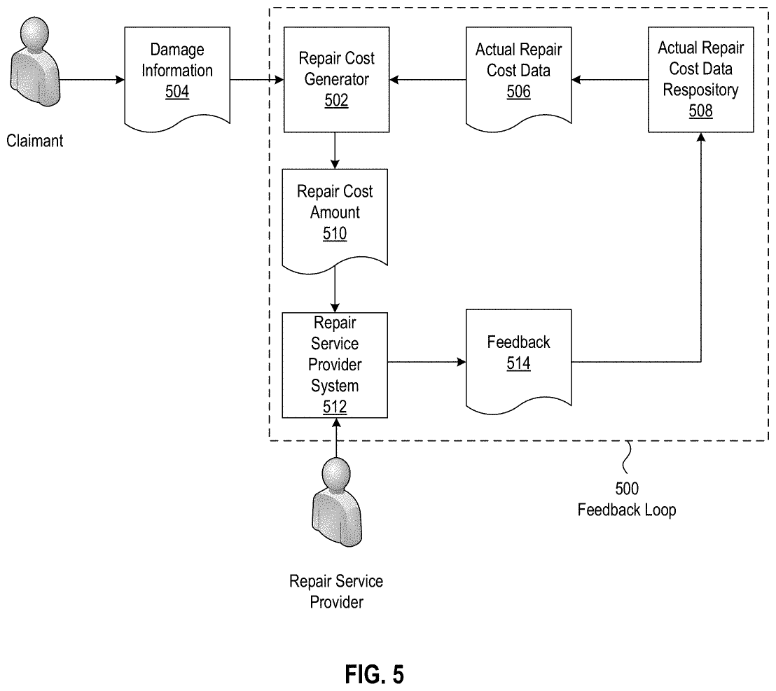

Referring now to FIG. 5, a block diagram of the feedback loop 500 provided by the enhanced claims processing system in accordance with at least one aspect of the present disclosure. As seen in FIG. 5, a repair cost generator 502 may receive damage information 504 from a claimant and actual repair cost data 506 from an actual repair cost data repository 508. As described above, the damage information 504 may describe or otherwise indicate the damage to an item such as a vehicle. The damage information 504 may identify the item type such as the make, model, and year where the item is a vehicle for example. The damage information 504 may also identify one or more areas or portions of the item that has been damaged. Where the item is a vehicle, for example, the damage information 504 may identify the location of the damage on the vehicle (e.g., front, rear, left side, right side, roof, etc.), or particular components of the vehicle that have been damaged (e.g., front/rear windshield, side windows, headlights, trunk, wheels, rims, etc.). The damage information 504, may include, for instance, readings from various sensors that have assessed the vehicle, images of the vehicle that depict the damage, recorded data retrieved from devices installed at the vehicle that operation or use of the item, answers from the claimant in response to questions posed regarding the circumstances in which the damage occurred, and other types of information related to damage of the item. The actual repair cost data 506 retrieved from the actual repair cost data store 508 may depend on the damage information received from the claimant. For example, the actual repair cost data 506 retrieved may be associated with the type of item that was damaged and correspond to the area or components indicated as damaged in the damage information 504.

Based on the damage information 504 received and the actual repair cost data 506 retrieved, the repair cost generator 502 may generate a repair cost amount 510. As described above, the repair cost amount 510 may be used to select a non-negotiable payment amount for repairing the damage to the item. The repair cost amount 510 may then be provided to a repair service provider system 512, e.g., as part of a non-negotiable payment included in a work order. A repair service provider that has accepted the terms of the work order may repair the damaged item and receive the non-negotiable payment as remuneration for performing the repair. The repair service provider may then use the repair service provider system 512 to generate feedback 514 regarding the repair of the item. The feedback 514 may identify the actual cost to repair the item. The feedback 514 may also indicate the area or components of the item and respective actual costs to repair each area or component. The feedback 514 may also include a total actual repair cost that is the sum of the actual repair costs for each area or component. The feedback 514 may also identify damaged areas or components not identified in the initial work order as well as the cost to repair those unidentified damaged areas or components. The cost of repairing unidentified damaged areas or components may be included in the total actual repair cost identified in the feedback 514. The feedback 514 from the repair service provider system 512 may be used to update the actual repair cost data repository 508. Upon subsequent receipt of similar damage information, the actual repair cost data 506 retrieved will have taken into account the feedback 514 previously received. As a result the repair cost amount 510 generated by the repair cost generator 502 is more likely to be closer to the actual repair cost. This feedback loop 500 may repeat many times over with feedback received from multiple repair service providers. As noted above, the more feedback received, the closer repair cost amounts may be to the actual repair costs reported by the repair service providers in their feedback.

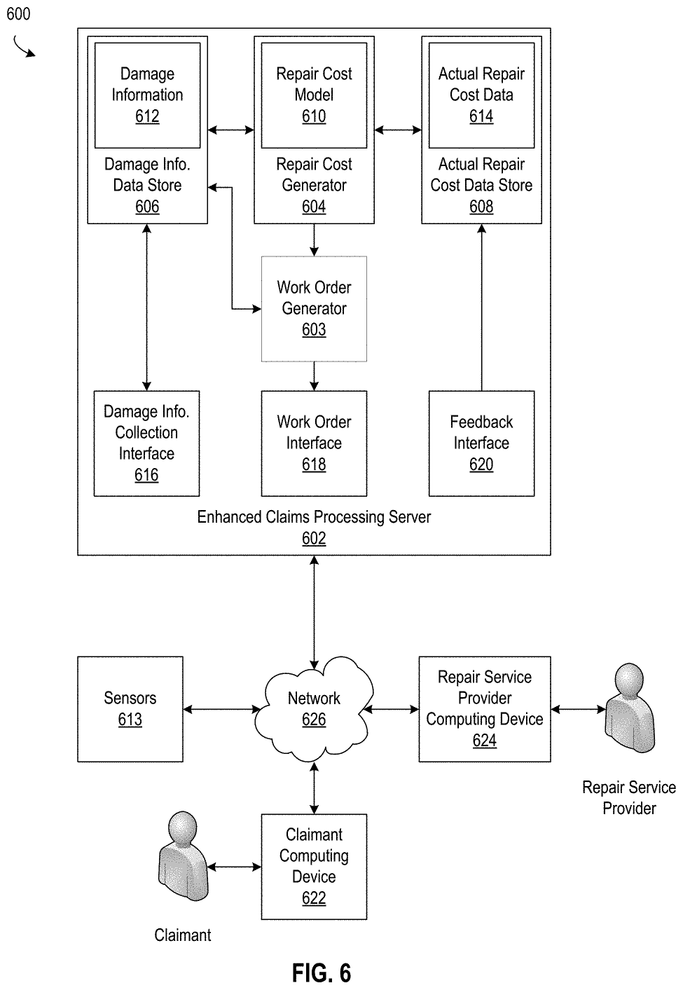

Referring now to FIG. 6, a block diagram of an example of an implementation of an enhanced claims processing system 600 is shown. The enhanced claims processing system 600 includes an enhanced claims processing server 602. The enhanced claims processing server 602 may include at least some of the same components and be configured to carry out at least some of the same functionality as the enhanced claims processing servers 101 and 401 described above with reference to FIG. 1 and FIG. 4 respectively. Like the enhanced claims processing servers 101 and 401, the enhanced claims processing server 602 is a special-purpose computing device programmed with instructions to perform functionality described herein. The enhanced claims processing server 602, in this example, includes a work order generator 603 in signal communication with a repair cost generator 604. The work order generator 603 and the repair cost generator 604 are each in signal communication with a damage information data store 606. The repair cost generator 604 is also in signal communication with an actual repair cost data store 608.

The work order generator 603, in this example, is configured to generate the work orders that describe the damage to an item and select a non-negotiable payment amount based on the repair cost generated by the repair cost generator as described above. The work order generator 603 may also be configured to select the non-negotiable payment amount based on the repair cost generated by the repair cost generator. The work order generator 603 may, for example, select the bonus to be applied to the repair cost generated in order to incentivize a repair service provider to accept the non-negotiable payment amount. As noted above, the non-negotiable payment amount may be equal to, in some implementations, the repair cost plus x% of the repair cost. The work order generator 603 may also be configured to select a set of repair service providers to initially transmit the work order to. As also noted above, repair service providers that agree to participate in the feedback process may receive a preferred status that allows them to receive work order offers before other repair service providers. The work order generator 603 may thus select a set of repair services providers based on a preferred status. The work order generator 603 may also select the set of repair service providers based on the consistency or timeliness with which the repair service providers provide feedback. The work order generator 603 may, for example, select the repair service providers that most consistently and quickly provide feedback as the first set of service providers the work order is transmitted to. In this way, an insurance company that provides the enhanced claims processing system may incentivize repair service providers to participate in the feedback process and accept the non-negotiable payment amounts.

The repair cost generator 604, in this example, includes a repair cost model 610, which may be the same as or at least similar to the repair cost model 502 described above with reference to FIG. 5. The damage information data store 606 may store the damage information 612 received from claimants or sensors 613. The sensors 613 may be the same as or at least similar to the sensors 305 and 403 described above with reference to FIG. 3 and FIG. 4 respectively. The damage information 612 stored at the damage information data store 606 may include the same types of information as the damage information 504 described with reference to FIG. 5. The actual repair cost data store 608 may store actual repair cost data 614 which may similarly include the same types of information as the actual repair cost data 506 described above with reference to FIG. 5. The actual repair cost data may also include data identifying different types of items (e.g., a make, model, and year of a vehicle) as well as the actual costs to repair or replace various areas of those items (e.g., the front, rear, or side areas of the vehicle) or various components of those items (e.g., bumper, headlight, windshield, side mirror, door panel, etc. of a vehicle). The actual repair cost data 614 may also include the labor costs associated with repairing a damaged item. The repair cost generator 604 may retrieve the damage information 612 and the actual repair cost data 614 from the respective data stores 606 and 608 and configure the repair cost model 610 with the damage information and actual repair cost data retrieved. As noted above, the repair cost generator may retrieve the portions of the actual repair cost data 614 that correspond to the damage information 612 received from the claimant. The repair cost generator 604 may configure the repair cost model 610 in this fashion for each repair cost generated in response to receipt of an FNOL from a claimant regarding damage to an item. The actual repair cost data 614 may also be utilized to adjust insurance rates for vehicles based on the observed costs associated with fixing those vehicles. If the actual repair cost data indicates that it is relatively less expensive to fix one type of vehicle, then the rates to insure that vehicle may be adjusted lower as a result. Similarly, if the actual repair cost data indicates that it is relatively more expensive to fix another type of vehicle, then the rates to insure that other vehicle may be adjusted higher as a result.

In some example implementations, a repair cost generator may additionally or alternatively utilize telematics data received from a telematics device to generate the repair cost amount. In these other example implementations, the repair cost generator may configure a repair cost model with telematics data received from a telematics device associated with the damaged item and telematics data associated with previously settled claims. The repair cost model may thus generate a repair cost for repairing a damaged item based on comparisons to previously settled claims associated with similar telematics data. For example, if previously settled claims associated with a set of telematics data resulted in an average payment of $x to a claimant, then the repair cost generator may also generate a repair cost of $x if a new claim is associated with a similar set of telematics data. A repair cost generator may also, in some examples, provide implementations to configure the repair cost model and generate a repair cost based on a combination of damage information and telematics information received. In some example implementations, the repair cost model may comprise a lookup table.

The enhanced claim processing server 602, in this example, also includes various interfaces to facilitate receiving damage information from a claimant, providing work orders to repair service providers, and receiving feedback from repair service providers. In particular, the enhanced claim processing server 602, in this example, includes a damage information collection interface 616, a work order interface 618, and a feedback interface 620. The enhanced claim processing server 602 may use these interfaces to communicate with a claimant computing device 622 and a repair service provider computing device 624 through a network 626 such as, e.g., the Internet. The interfaces may include, for example, web servers that provide web pages to the claimant computing device 622 and the repair service provider computing device 624. The interfaces may additionally or alternatively include mobile servers for communicating with the claimants and repair service providers via mobile applications installed at the claimant computing device 622 and the repair service provider computing device 624.

The enhanced claims processing server 602 may receive damage information 612 from a claimant via a damage information collection web page provided by the damage information collection interface 616. The damage collection web page may include input elements that enable the claimant to identify the item that was damaged and indicate the particular areas or components of the item where damage occurred. The damage information collection interface 616 may forward the damage information 612 received from the claimant to the damage information data store 606 for storage.

The enhanced claims processing server 602 may transmit work orders to the repair service providers via a work order web page provided by the work order interface 618. The work order generator 603, in this example, is in signal communication with the work order interface 618 and may provide the work order generated for transmission to the repair service provider, e.g., in a work order web page. The work order web page may identify the item that was damaged, a description of the damage to the item, the non-negotiable payment amount, and the terms of the work order. The enhanced claims processing server 602 may also receive acceptance or rejection of the terms of a work order through the work order web page. A claimant may also obtain a copy of the work order for the item via the work order web page. The copy of the work order may include information identifying the repair service provider that accepted the terms of the work order.

The enhanced claim processing server 602 may receive feedback from the repair service providers via a feedback web page provided by the feedback interface 620. The feedback web page may include input elements that allow the repair service provider to identify areas or components of the item that were repaired and the actual cost to repair those items as described above. The feedback interface 620 may forward the feedback received from the repair service providers to the actual repair cost data store 608 for storage as actual repair cost data 614.

In some example implementations, the insurance company may limit the opportunity to receive non-negotiable payments to “in-network” repair service providers. If the “in-network” service providers do not include a repair service provider the claimant prefers, an insurance company may provide the claimant with incentives for selecting an “in-network” repair service provider. Such incentives may include, e.g., a reduced deductible on an insurance policy, no deductible on an insurance policy, reduced insurance premiums, expedited repair of the damaged item, a guarantee of the quality of the repair, and the like.

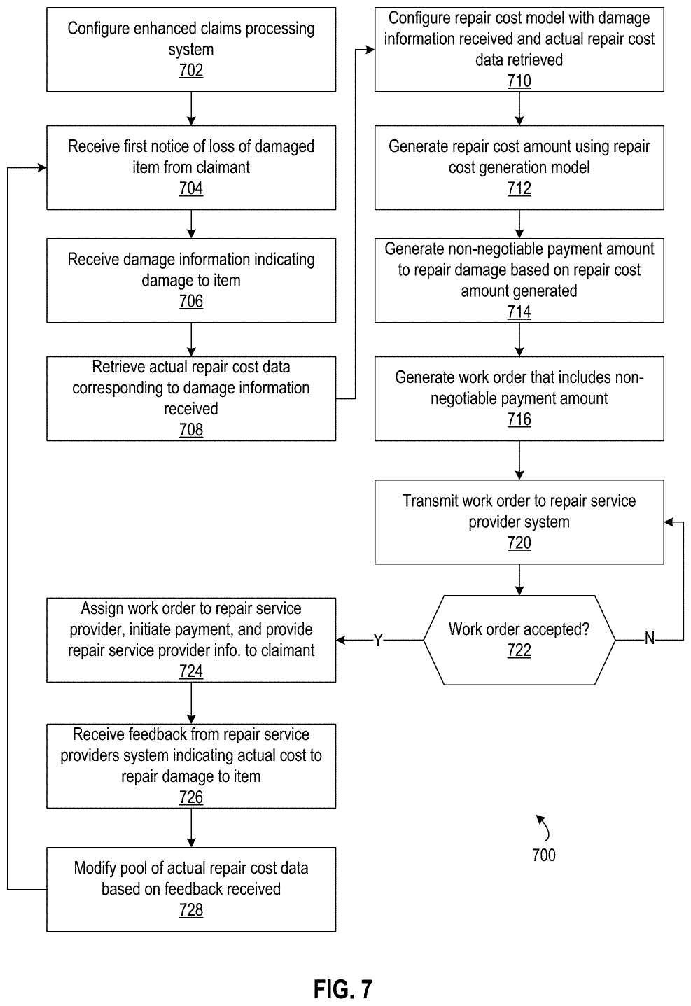

Referring now to FIG. 7, a flowchart 700 of example method steps for using an enhanced claims processing system with a feedback loop in accordance with at least one aspect of the present disclosure is shown. To process claims for damage to items, an enhanced claims processing system may be configured (block 702). Configuring the enhanced claims processing system may include seeding an actual repair cost data store with an initial set of data indicating the actual repair costs to repair a damaged item. As noted above, the actual repair cost data may include data indicating historical costs for repairing areas of a damaged item, repairing individual components of a damaged item, or replacing individual components of a damaged item.

Having configured the enhanced claims processing server, a first notice of loss may be received from a claimant regarding damage to an item (block 704). The enhanced claims processing system may also receive from the claimant damage information that indicates the damage to the item (block 706). The damage information may be received with or subsequent to the FNOL. Having received the damage information, the enhanced claims processing system may retrieve actual repair cost data that corresponds to the damage information received (block 708). The enhanced claims processing system may then configure a repair cost model using the damage information received and the actual repair cost data retrieved (block 710). The enhanced claims processing system may then utilize the repair cost model to generate a repair cost amount (block 712) and generate a non-negotiable payment amount for repairing the damaged item based on the repair cost amount (block 714). As noted above, the non-negotiable payment amount may equal the repair cost amount or include one or more bonuses to serve as incentives for accepting the terms of a work order with the non-negotiable payment.

The enhanced claims processing system may generate a work order that includes the non-negotiable payment amount (block 716) as described above. The enhanced claims processing system may then transmit the work order to one or more repair service provider systems (block 720) respectively maintained by one or more repair service providers. If one of the repair service providers accepts the terms of the work order (block 722:Y), then the enhanced claims processing system may assign the work order to that repair service provider, initiate payment of the non-negotiable payment amount to the repair service provider, and provide information associated with the repair service provider to the claimant (block 724), e.g., name, location, reservation time, and the like. The enhanced claims processing system may, in some example implementations, initiate payment of the non-negotiable payment amount to the repair service provider upon acceptance of the terms of the work order. In other implementations, the enhanced claims processing system may initiate payment of the non-negotiable payment amount upon receipt of the feedback from the repair service provider. In still other implementations, the enhanced claims processing server may initiate payment of a portion of the non-negotiable payment amount upon acceptance of the terms of the work order and initiate payment of the remaining portion of the non-negotiable payment amount upon receipt of the feedback from the repair service provider. If the work order is not accepted by a repair service provider (block 722:N), the enhanced claims processing system may transmit the work order to one or more additional repair service providers. In some example implementations, the enhanced claims processing server may transmit the work order to multiple repair service providers at once (e.g., multiple “in-network” service providers) in which case the work order is assigned to the first repair service provider that accepts the terms of the work order. In other example implementations, the enhanced claims processing server may transmit the work order to individual repair service providers in a sequential fashion whereby a subsequent repair service provider has the opportunity to accept the terms of the work order if a previous repair service provider rejects the terms of the work order. The sequence of repair service providers may be based on various criteria such as, e.g., customer rating, participation in the feedback process, location relative to the claimant, and so forth.

Having repaired the damaged item, the repair service provider may transmit feedback to the enhanced claims processing system indicating the actual cost to repair the item (block 726). As noted above the feedback may include a listing of the areas, components, or parts of the item that were repaired, individual costs to repair those portions of the item, and an overall cost to repair the item which may include a sum of the individual costs to repair the various portions of the item, labor costs, and so forth. The enhanced claims processing system may modify the pool of actual repair cost data based on the feedback received (block 728). Modifying the actual repair cost data based on the feedback may include adding new actual repair cost data to the pool of actual repair cost data as well as changing or removing existing actual repair data from the pool of actual repair cost data. As a result, the next time a FNOL is received regarding similar damage to a similar item, the repair cost amount generated by the repair cost model is more likely to be closer to the actual cost to repair the item ultimately reported by the repair service provider that repairs the item. With respect to vehicle repair, the number of vehicle repairs that occur daily represent an extensive source of potential repair data that may be harnessed to improve the generation of repair cost amounts. By minimizing the difference between the repair costs generated by the repair cost model and the actual repair costs reported by service providers, the need for estimating repair costs is therefore eliminated. By eliminating repair estimates, an insurance company may streamline the process of reporting damage to an item and having that item repaired. Although the present disclosure has been described in the context of automobile insurance and vehicle repair, the techniques described above may be suitably employed for other types of insurance and item repair including, for example, home insurance, boat insurance, and the like.

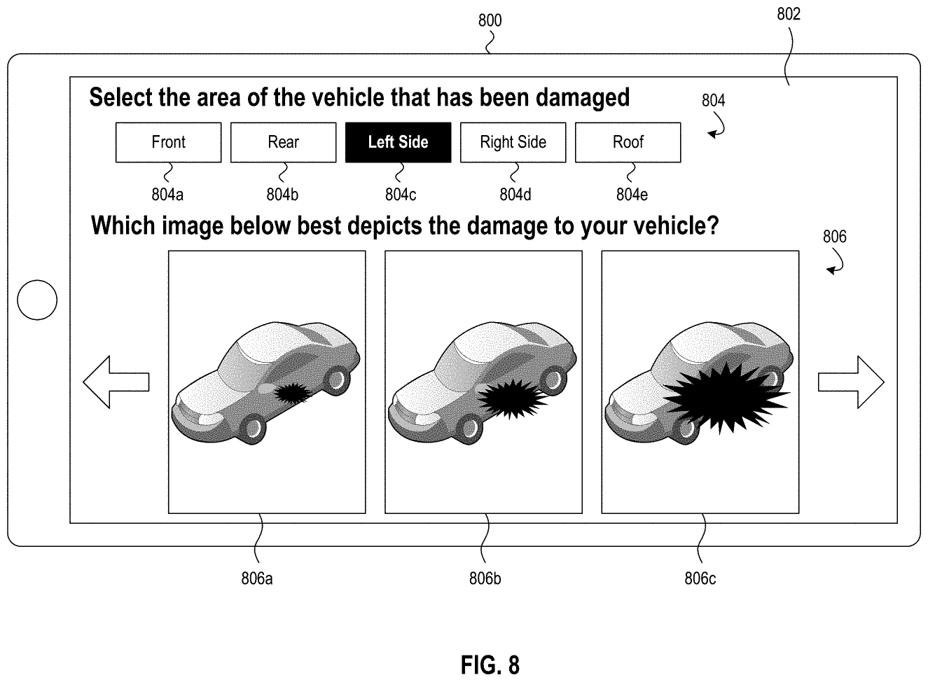

Referring now to FIGS. 8-10, approaches to collecting damage information from a claimant are described. Commonly-owned U.S. patent application Ser. No. 13/933,576 entitled “Feedback Loop in Mobile Damage Assessment and Claims Processing” and filed on Jul. 2, 2013, describes an approach to claims processing that involves collecting images of a damaged item from a claimant and using the images captured by the claimant to assess the damage to the item. In some circumstances, however, the computing devices available to a claimant may not be equipped or configured to capture images of the damaged item. In these circumstances, the approach below may be employed to collect damage information from the claimant without requiring the claimant to capture images of the damaged item.

As described in further detail below, an enhanced claims processing system may collect damage information from the user via images selected by the user that best represent the damage to the item. Referring to FIG. 8, an example of an implementation of a damage collection device 800 is shown at which a damage information collector 802 resides. The damage information collector 802, in this example, is configured to collect damage information regarding damage to a vehicle. As seen in FIG. 8, the damage information collector 802 presents a set of input elements 804 (collectively) the user may use to identify portions of the vehicle that has been damaged. The damage information collector 802, in this example, includes input elements for selecting areas of the vehicle that have been damaged, e.g., a “front” input element 804a, a “rear” input element 804b, a “left side” input element 804c, a “right side” element 804d, and a “roof” element 804e.

The set of elements 804 illustrated in FIG. 8 are shown by way of example only. Other implementations of the damage information collector may include additional or alternative input elements. In some implementations, for example, the set of input elements may include more granular areas of a vehicle, e.g., respective input elements for the “front,” “right,” “left,” “rear,” “top,” “front right side,” “rear right side,” “front left side,” “rear left side,” “front right,” “front left,” “rear right,” “rear left,” “window area,” “windshield area,” “panel area,” “door area,” “wheel area,” and other areas of the vehicle. In addition, some example implementations may include input elements for selecting individual components of the vehicle have been damaged such as, e.g., “front windshield,” “rear windshield,” “front right headlight,” “front left headlight,” “rear right brake light,” “rear left brake light,” “front windshield,” “rear windshield,” “front bumper,” “rear bumper,” “hood,” “trunk,” “roof,” “panel,” “front left door,” “front left window,” “rear left door,” “rear left window,” “front right door,” “front right window,” “rear right door,” “rear right window,” “left side mirror,” “right side mirror,” “front left tire,” “rear left tire,” “front right tire,” “rear right tire,” and other components of the vehicle. Other types of items may include additional and alternative areas and components that will be appreciated with the benefit of this disclosure. Areas of an item may include multiple components of the item, e.g., a “front right side” area of a vehicle may include the front bumper, hood, and front right headlight of the vehicle.

The set of input elements may also include input elements that allow the user to select the type of damage that occurred to the selected portion of the item, e.g., dent, puncture, fire, detachment, crack, shatter, etc. Having selected an input element to indicate the portion of the item that was damaged, the claimant may then select an input element to indicate the type of damage that occurred. The damage information collector 802 may allow the user to select multiple input elements to indicate the type of damage that occurred, e.g., if the damage to a portion of a vehicle includes both dents and punctures.

The damage information collector 802 may also present a series of images 806 (collectively) that depict increasing degrees of damage to the selected area or component of a reference item. Each image in the series of images 806 may depict relatively more damage than the image that preceded it. For reference, the first image in the series of images 806 may, for example, depict no damage to the area or component of the reference item. The claimant may then scroll through the series of images 806 to select which image best depicts the damage to the item associated with the insurance claim made. As shown by way of example in FIG. 8, the “left side” input element 804c has been selected, and the series of images 806 include images that depict increasing degrees of damage to the left side of a reference vehicle. In this example, image 806a depicts a relatively small amount of damage to the left side of the reference vehicle, image 806b depicts a relatively moderate amount of damage to the left side of the reference vehicle, and image 806c depicts a relatively large amount of damage to the left side of the reference vehicle. Other images in the series of images 806 may depict relatively more or less damage to the reference vehicle. In addition, the series of images may be selected such that they depict the type of damage indicated by the claimant via the selection of input elements corresponding to the type of damage that occurred. Some of the images presented to the claimant may depict the entirety of the reference item, and some of the images presented to the claimant may only depict portions of the reference item, e.g., close-up images on various areas or components of the reference item. The series of images may be a series of photos of the reference item, a series of graphical representations of the reference item, and combinations thereof.

In addition, the damaged item and the reference item may be of the same item type. As an example the reference item depicted in the series of images may have the same model number as the damaged item. Where the damaged item is a vehicle, for example, the reference item may depict a vehicle having the same make, model, and year as the damaged vehicle. In some example implementations, the damaged item and the reference item may be different—but similar—item types, e.g., items that are similar but have different model numbers. Where the damaged item is a vehicle, for example, the reference item may be a vehicle that has a different year than the damaged vehicle. In some example implementations, an estimated cost to repair the damaged item may be determined even where the series of images depict an item of a different make or model, e.g., a different vehicle make, model, and year. Knowing the item type of the damaged item and the areas and components that were damaged may be sufficient to estimate a cost to repair the item even when the damage information is collected using depictions of a different type of reference item.

The claimant may select as many areas or components of the item as necessary to comprehensively indicate the damage to the item. The damage information collector 802 may identify the images selected by the user in the damage information transmitted to the enhanced claims processing system. As described in further detail below, the damage collection device 800 may be in signal communication with the enhanced claims processing server to transmit communications identifying the portions of the damages item selected by the claimant, receive communications that include the series of images corresponding to the damage portions selected, and transmit communications identifying the images selected by the claimant as best representing the damage to the item.

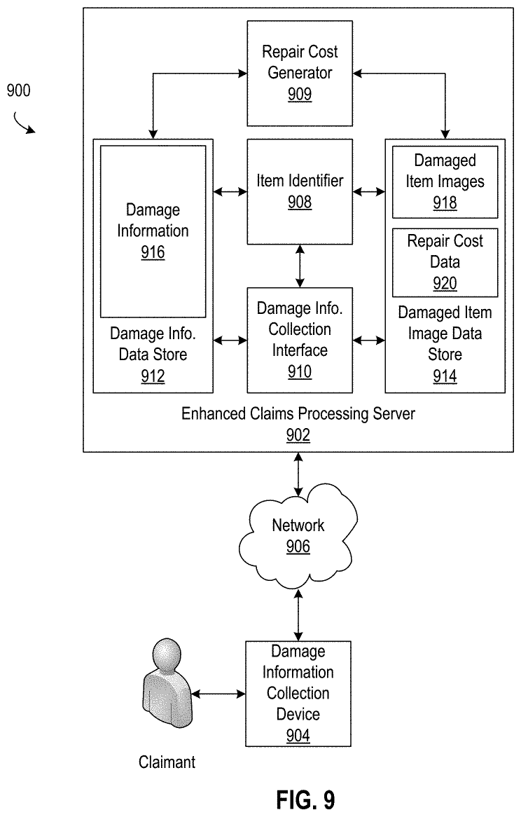

Referring now to FIG. 9, another example of an implementation of an enhanced claims processing system 900 in accordance with at least one aspect of the present disclosure is shown. The enhanced claims processing system 900 may be similar to the enhanced claims processing system 600 described above with reference to FIG. 6. The enhanced claims processing system 900 similarly includes an enhanced claims processing server 902 which may include at least some of the same components and be configured to carry out at least some of the same functionality as the enhanced claims processing servers 101, 401, and 602 described above with reference to FIG. 1, FIG. 4, and FIG. 6 respectively. The enhanced claims processing server 902, in this example, is in signal communication with a damage information collection device 904 via a network 906 such as the Internet. The damage information collection device 904 may be the same as or at least similar to the damage information collection device 800 described above with reference to FIG. 8. As described, a claimant may utilize the damage information collection device 904 to provide damage information that indicates the damage to a damaged item.

Like the enhanced claims processing servers 101, 401, and 602, the enhanced claims processing server 902 of FIG. 9 is also a special-purpose computing device programmed with instructions that, when executed, perform to collect damage information from the damage information collection device 904 and determine an generate a cost to repair a damaged item based on images selected as best depicting the damage that occurred to the item. Again, although only a single enhanced claims processing server 902 is shown in FIG. 9, other implementations may include multiple special-purpose computing device that are interconnected with one another and programmed with instructions to respectively perform the functionality identified above.

The enhanced claims processing server 902, in this example, includes an item identifier in signal communication with a damage information collection interface 910, both of which are also in signal communication with a damage information data store 912 and a damaged item image data store 914. The damaged item image data store 914 may store the damaged item images 918. In the context of damaged vehicles, for example, the damaged item images 918 may include images of damaged vehicles. The damaged item images 918 may include multiple images for the same type of vehicle whereby individual images of that vehicle depict varying degrees of damages to various areas or components of the vehicle, e.g., as described above with reference to FIG. 8.

The damage information collection interface 910 may be configured to exchange communications with the damage information collection device 904. The exchanged communications may identify the selections indicating the damaged portions of the item, deliver one or more of the damaged item images 918 for presentation to the claimant, and indicate the images selected by the claimant as best representing the damage to the item. In use, the damage collection interface 910 may receive a communication indicating a portion of the item the claimant has identified as damaged. The damage collection interface 910 may then retrieve a series of damaged item images from the set of damaged item images 918 (i.e., a subset of images) that correspond to the damaged portion identified and send those images to the damage information collection device 904. The damage information 916 received via the damage information collection interface 910 may thus include information indicating which damaged item images 918 were selected by the claimant as best representing the damage to the item. The damage information data store 912 may store the damage information 916 which may also be associated with a record of the FNOL provided by the claimant.

Metadata stored with or otherwise associated with the respective damaged item images 918 may describe the item itself as well as the type of damage depicted in the image. With respect to damaged vehicles, image metadata may include, e.g., the make, model, and year of the vehicle; the area or component of the vehicle that is damaged in the image; and the type of damage depicted in the image. The image metadata may thus correspond to the selectable input elements (e.g., input elements 804) presented to the claimant at a damage information collector (e.g., damage information collector 802) residing at the damage information collection device 904. The damaged item image data store 914 may also store repair cost data 920 that is respectively associated with one or more of the damaged item images 918. The enhanced claims processing server 902 may utilize the repair cost data 920 when generating a repair cost amount based on the damaged item images 918 selected by a claimant as best representing the damage to an item.

The item identifier 908, in this example, may be configured to automatically identify the type of item that was damaged and its corresponding characteristics. In some example implementations, the FNOL received from the claimant may include a customer number or unique identifier associated with the item such as, e.g., a vehicle identification number (VIN) of a vehicle. The item identifier 908 may perform a lookup in a customer database using the customer number to determine the items (e.g., vehicles) associated with the claimant. For example, an insurance customer database may store the VINs of the vehicles insured by an insurance policy associated with the customer. The item identifier 908 may thus retrieve the VIN of the vehicle associated with the claimant using the customer number provided by the claimant. If multiple items are associated with the claimant, the enhanced claims processing server may exchange communications to confirm which of the items was damaged. Having retrieved the unique identifier for the damaged item, the item identifier 908 may retrieve (e.g., from an item database) descriptive information for that item. In the context of vehicles, the descriptive information may include the make, model, and year of the vehicle. The descriptive information may also include information describing individual components of the item such as, e.g., part number, dimensions, repair cost, replacement cost, and so forth. Having identified the damaged item, the item identifier may select one or more of the damaged item images 918 depicting that item to present to the user.

The repair cost generator 909, in this example, may be configured to generate an estimated cost to repair the damaged item based on the images selected at the damage information collection device 904. The repair cost generator 909 may retrieve the damage information 916 from the damage information data store 912 that indicates the images selected as best representing the damage to the item. The repair cost generator 909 may then retrieve the repair cost data 920 associated with the selected images from the damaged item image data store 914. The repair cost generator 909 may then generate an estimated cost to repair the item based on the repair cost data 920 retrieved, e.g., by summing the repair cost data.

By obtaining pre-stored images of damaged items that depict various degrees of damage to an item and allowing a claimant to select the image that best represents the actual damage to an insured item, an insurance company may advantageously obtain damage information and a corresponding repair cost without inspecting the item. Furthermore, the feedback loop described above may be leveraged to obtain the images depicting damage to the items and the corresponding cost to repair the damage. In one example scenario, an insurance company may receive a selection of a set of images selected by a claimant as best depicting the actual damage that has occurred to a vehicle. The insurance company may generate a repair cost amount based on the repair cost data associated with the selected images. During the repair process, the repair service provider may capture images of the actual damage to the item and include those captured images in the feedback provided to the insurance company along with the actual repair cost to repair the damage. The insurance company may then update the pool of damaged item images and associated repair cost data based on the feedback received from the repair service providers. The images of actual damage received from the repair service providers may thus appear in a set of damaged item images presented to a subsequent claimant for the same type of damaged item.

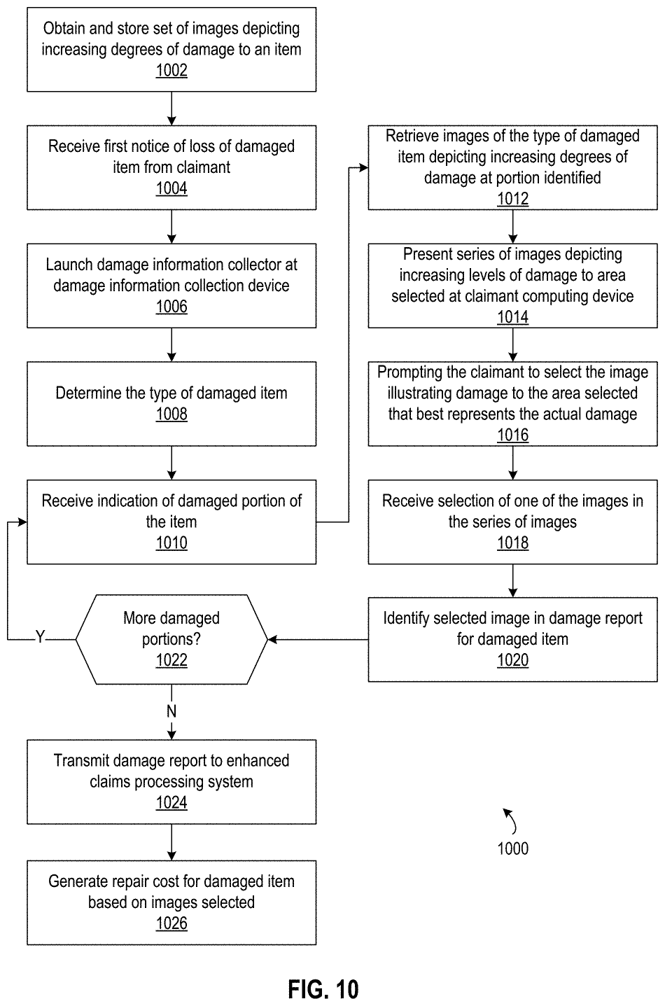

In FIG. 10, a flowchart 1000 of example method steps for collecting damage information related to a damaged item in accordance with at least one aspect of the present disclosure is shown. A set of images respectively depicting increasing degrees of damage to an item may be obtained and stored at an enhanced claims processing system (block 1002). The enhanced claims processing system may receive a first notice of loss from a claimant regarding damage to an item (block 1004) such as a vehicle. A damage information collector may be launched at a damage information collection device (block 1006) operated by the claimant. The type of damaged item may be determined (block 1008), e.g., automatically by the enhanced claims processing system or via information received from the claimant indicating the type of damaged item.

The enhanced claims processing system may also receive an indication of the damaged portion of the item (block 1010), e.g., a damaged area or a damaged component. The enhanced claims processing system may then retrieve a series of images depicting increasing degrees of damage to an item of the same type at the portion identified (block 1012). That set of images may then be presented to the claimant (block 1014) and made available for selection. The claimant may then be prompted to select which of the images presented best represents the damage that occurred to the damaged item at the portion identified (block 1016). A selection of one of the images may be received from the claimant (block 1018), and that selection may be identified in a damage report prepared for the damaged item (block 1020). The damage information collector at the damage information collection device may be configured to prepare the damage report for the damaged item. If there are additional portions of the damaged item to indicate (block 1022:Y), then the damage information collector may receive an additional selection indicating another portion of the item that was damaged, and these steps may be repeated to obtain a selection of an image that best represents the damage to that other portion.

Once no more portions of the damaged item remain to be identified (block 1022:N), the damage information collector may transmit the damage report to the enhanced claims processing system (block 1024). The damage report may include unique identifiers respectively associated with the images selected by the claimant at the damage information collector. The enhanced claims processing system may store damage information at a data store that corresponds to the damage report received. The enhanced claims processing system may then generate a repair cost based on the images selected by the claimant as best representing the damage to the item (block 1026). In this way, an insurance system may advantageously generate a repair cost for the damage item without having inspected the damaged item. An insurance company may employ the approach described above in situations where it would be difficult or cost-prohibitive to have an inspector examine the damage to the item.

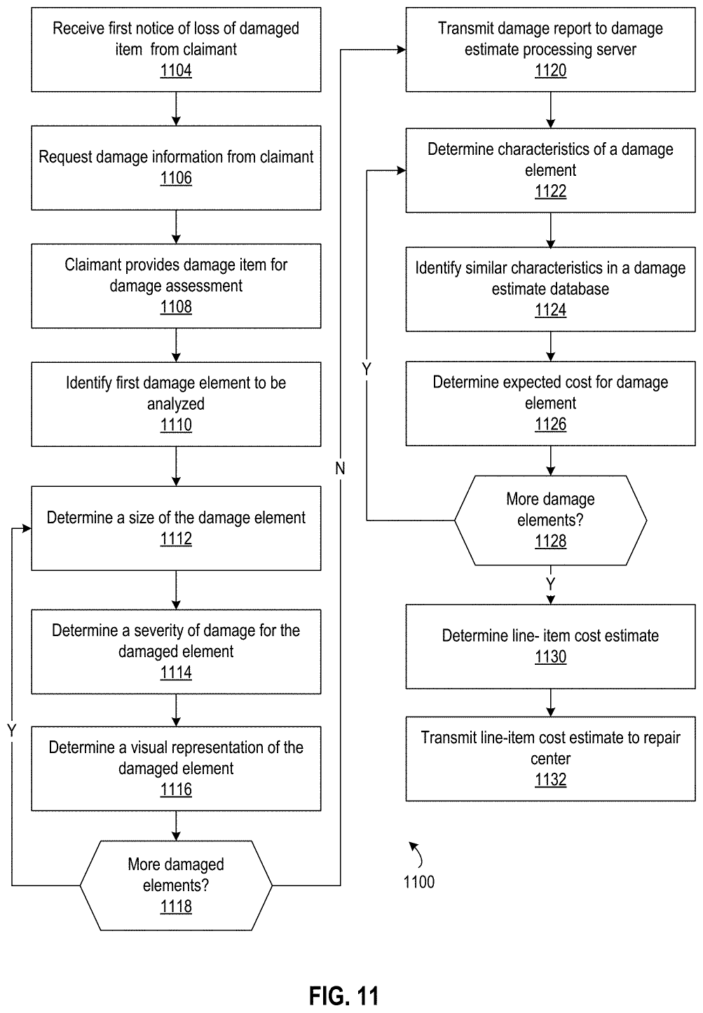

In FIG. 11, a flowchart 1100 of example method steps for collecting damage information for multiple damage elements of a damaged item is shown. Damage information may be an instance of damage information as described herein. A damaged item may be an insured item, such as an insured item 301. One or more aspects of flowchart 1100 may be compatible and/or interspersed with one or more aspects of other methods and/or systems described herein. A claimant may report a notice of loss that an item has been damaged (block 1104). The damage information collector may request additional information from the claimant (block 1106). For example, the damage information collector may request the claimant to provide damage information about a damaged item. The damaged item may have received multiple instances of damage (e.g., damage elements). For example, the claimant's vehicle may have been exposed to hail and may have suffered multiple instances of hail damage where hail dented, cracked, or otherwise damaged the claimant's vehicle.

The claimant may provide the damaged item for a damage assessment (block 1108). The damage information collector may collect various damage information about the damaged item. The damage information collector may use a system, such as an enhanced claims processing systems disclosed herein in conjunction with an enhanced claims processing apparatus such as the enhanced claims processing apparatus above regarding FIG. 4, to determine information about damage elements for the damaged item. A claimant may transport his or her vehicle to a facility for analysis. The facility may contain an area where the enhanced claims processing apparatus may automatically determine one or more damage elements for the damaged item. In some instances, a driver positioning the vehicle within the area may automatically trigger the analysis. For example, when a vehicle is driven into the area, one or more sensors (e.g., pressure sensors under the front wheels of the vehicle, proximity sensors that detect the presence of the body of the vehicle, etc.) may activate the system and/or indicate that the data collection process is ready to begin. The system may use multiple cameras (such as detailed imaging sensors), laser sensors, depth sensors, and other types of sensors to determine a size, severity, and a visual representation for the damage element. The system may determine the location of multiple hail marks using automated identification of instances of hail damage.

The system may identify a first damage element to be analyzed (block 1110). For example, the system may determine the first instance of hail damage on a vehicle. The system may then determine the size of the damage element (block 1112). For example, the system may determine that a given instance of hail damage is five centimeters wide and three centimeters deep using imaging and/or depth sensors. The system may then determine the severity of damage for the damaged element (block 1114). Severity may be indicated according to levels, such as a “minor,” “moderate,” “severe” designation. In one example, a small, round dent may be easy to repair and classify the dent as a “minor” repair. In another example, the system may determine that a dent may not be round, which may be difficult to repair, and classify the dent as a “moderate” repair. In yet another example, the system may determine that a dent has compromised the structure of the vehicle, requiring replacement of a panel, and classify the dent as a “severe” repair. Severity may be indicated using other methods, as well. For example, the system may classify a crack on a windshield as a “replacement” because it exceeds a predetermined dimension threshold (e.g., the crack extends for more than twelve inches). The system may then determine a visual representation of the damaged element (block 1116). The system may take one or more photographs of the damage element, which may help with later identification, claims adjusting, and/or repair. For example, the system may take a close-up photograph of an instance of hail damage and a wider shot showing the location of the hail damage relative to the vehicle. This may assist a repair service provider (e.g., a repair center) in determining what damage should be repaired and/or how much repairs may cost. The system may then determine if additional damage elements exist for the damaged item (block 1118). For example, the system may determine that additional instances of hail damage exist on a vehicle. If additional damage elements exist, the system may begin analyzing the next element (i.e., return to block 1112).

After analyzing the damage elements, the system may transmit a damage report to a damage estimate processing server (block 1120). For example, an enhanced claims processing apparatus 400, such as one discussed in FIG. 4, may transmit data such as that which is collected in blocks 1110-1118 regarding the damage elements of the damaged item.

In some instances, data may comprise damage information, which may be formatted using one or more tags. For example, tags regarding damage information may be as follows:

```
<damage report>
  <component>
    <type>windshield</>
    <damage>
      <type>crack</>
      <location>top-left</>
      <severity>minor</>
    </damage>
    <damage>
      <type>crack</>
      <location>middle</>
      <severity>replacement</>
    </damage>
  </component>
  <component>
    <type>hood</>
    <damage>
      <type>dent</>
      <depth>0.5</>
      <diameter>3.2</>
      <severity>minor</>
    </damage>
    <damage>
      <type>dent</>
      <depth>1.2</>
      <diameter>6.7</>
      <severity>moderate</>
    </damage>
  </component>
</damage report>
```

Upon receipt of damage information from an enhanced claims processing apparatus, the damage estimate processing server (block 1120) may automatically process the tags to generate a record and/or report of the damage corresponding to the characteristics and/or attributes associated with the tags. The server may further associate with the record one or more photographs of the vehicle and/or damage on the vehicle. The photographs may be used to identify or provide characteristics of the various damage elements of the vehicle. In some instances, metadata may be associated with the photographs. For example, metadata may specify that a photograph of a dent is taken of the hood at a forty-five degree angle near the front-left portion of the hood.

The damage estimate processing server may include a repair cost generator. Upon generation of a damage record and/or report, the damage estimate processing server may trigger a signal which causes the damage estimate processing server to determine characteristics of the damage element of the damaged item (block 1122). For example, the damage estimate processing server may determine that the damage element is hail damage to a hood is a dent caused by hail damage with a depth of 1.2, a diameter of 6.7, and of moderate severity based on one or more received tags. In another example, the damage estimate processing server may determine that the aggregated damage elements associated with the hood may require a replacement of the hood, and characterize the damage elements as requiring replacement. Using the characteristics of the damage elements, the damage estimate processing server may identify a profile with similar characteristics in a damage estimate database (1124). The damage estimate database may store damage profile records. Each damage profile record may include one or more of the following attributes: type, width, height, depth, severity, location, cause, panel type, region, paint type, structural damage, and/or any other suitable attribute. A similar damage profile may be located by querying the database for the damage profile record wherein the one or more attribute(s) match or approximate the tags and/or characteristics of the damage element. A damage profile record may be deemed to be a match when the difference between the value of the attribute does not exceed the determined value by more than a threshold amount (e.g., between 2% and 10%). For example, the damage estimate processing server may identify database entries corresponding to dents from hail damage with a depth of 1.2, a diameter of 6.7, and of moderate severity to hoods of the make and model of the vehicle corresponding to the damaged item and for the region where the repair may occur based on a comparison with one or more damage profile records in a damage estimate database. In some instances, the damage estimate processing server may determine that the damage was pre-existing based on one or more attributes described herein. For example, a dent may have an irregular shape that may not correspond to hail damage and be dented from the side rather than from above, so the server may flag the dent as pre-existing damage. The damage estimate processing server may then determine an expected cost for the damage element based on a cost estimate for the database entry. The entry may be local to a region, type of damage item, level of damage, and/or any other factor that may influence the cost of repair. For example, a damage estimate processing server may determine that a ten inch crack on a windshield may require replacement, and replacement windshields in the San Antonio, Tex. area are $100 with $20 in labor. In hail damage cases, a standard matrix for hail damage repair costs may be used. For example, a damage estimate processing server may determine that a two-inch deep, four-inch wide dent to the roof of a German automobile may cost $42 to repair. After determining the expected cost for the damage element, the damage estimate processing server may determine if more damage elements should be analyzed. If so, the damage estimate processing server may analyze the next damage element (block 1122). Otherwise, the damage estimate processing server may trigger a signal which initiates determining a line-item cost estimate for the damaged item.

A damage estimate processing server may determine a line-item cost estimate 1200 to repair a damaged item (block 1130) based on the expected cost of repair for the damage elements of the damaged item. The line-item cost estimate may list each damage element along with a cost of repair for that damage element. Further, the line-item cost estimate may include further information. The line-item cost estimate may include one or more photographs 1202 (such as the visual representation of the damaged element). The one or more photographs 1202 may assist a repair center in determining the location and/or severity of damage to be repaired.

The line-item cost estimate may also include a severity rating 1204 for one or more damage elements. The severity rating 1204 may indicate that one or more damage elements surpass a threshold such that the one or more damage elements require additional work and/or have a higher cost of repair. The system may determine which method may be the most appropriate and/or preferred method of repair for a damage element based on a characteristic associated with the damage element. In some instances the method of repair may be determined based on a comparison of characteristics associated with the damage element against one or more entries in a database, such as the damage estimate database. For example, small dents from hail damage may be repairable using suction. More significant incidences of hail damage may require the removal of panels for a technician to access the dents from behind in order to pop the dent out. Severe incidents of hail damage may require replacement of the part, such as the hood. In another example, cracks in a windshield beyond a given length may require replacement while smaller cracks may be filled in with an epoxy. By giving an indication of severity, this may inform the repair center of what actions the repair center may be authorized to take, and provide additional compensation for those actions, if needed. In some instances, the severity rating 1204 may indicate an allotment of time given for repair based on one or more severities associated with one or more damage elements. For example, a “minor” or level 1 rating may allot three hours, a “moderate” or level 2 rating may allot seven hours, and a “severe” or level 3 rating may allot ten hours.

The line-item cost estimate may comprise additional information related to the damaged item. The line-item cost estimate may include prior damage information 1206 for the damaged item. In some instances, the line-item cost estimate may identify prior damage based on previous reports and/or damage information associated with the vehicle (e.g., stored at the server or another server such as a vehicle history server). In other instances, the line-item cost estimate may identify prior damage based on pre-existing damage elements flagged by the damage estimate processing server. For example, the line-item cost estimate may indicate that a dent was not caused by hail and should not be repaired. The line-item cost estimate may indicate aftermarket parts that are in use or may be used on the vehicle. For example, the line-item cost estimate may indicate that a vehicle has a modified carbon fiber hood, which does not qualify under a customer policy and should not be repaired. In another example, the line-item cost estimate may indicate which types or makes of roofing panel may be used to replace a damaged roofing panel. In some instances, the line-item cost estimate may be used as feedback for a repair cost generator, such as repair cost generator 502, as described herein.

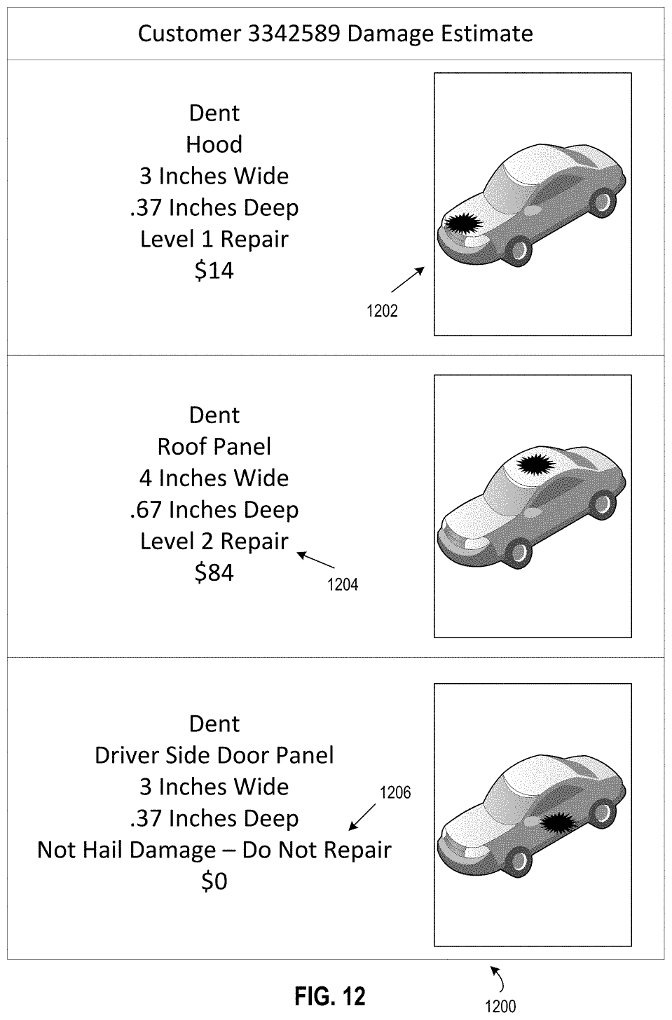

After calculating the line-item cost estimate, the damage estimate processing server may transmit the cost estimate to a repair center (block 1132). In some instances, the line-item cost estimate may be formatted consistent with FIG. 12. In other instances, the line-item cost estimate may be transmitted using a markup language such as follows:

```
<cost estimate>
  <component>
    <type>windshield</>
    <damage>
      <type>crack</>
      <location>top-left</>
      <severity>minor</>
      <cost>0</>
    </damage>
    <damage>
      <type>crack</>
      <location>middle</>
      <severity>replacement</>
      <cost>200</>
      <part>ASH34521</>
    </damage>
  </component>
  <component>
    <type>hood</>
    <damage>
      <type>dent</>
      <depth>0.5</>
      <diameter>3.2</>
      <severity>minor</>
      <cost>15</>
    </damage>
    <damage>
      <type>dent</>
      <depth>1.2</>
      <diameter>6.7</>
      <severity>moderate</>
      <cost>40</>
    </damage>
  </component>
</cost estimate>
```

In some instances, the damage estimate may be automatically transmitted to multiple repair centers, which may accept the repair job based on bidding or a first come, first served basis. In some other instances, the line-item cost estimate may be transmitted to the customer, who may present the estimate to a repair center of their choosing or from a list of authorized repair centers. In some instances, the repair center may respond to the line-item cost estimate indicating whether they will or will not repair the damaged item, or one or more damage elements of the damaged item, at the price indicated by the line-item cost estimate. For example, a repair center may receive a line-item cost estimate, and may choose to elect which items they may repair. In some instances, a threshold amount of repairs may be needed to accept the offer of repair services. For example, a repair center may be required to accept at least 80% of repairs. In another example, a repair center may be required to accept all repairs. If the threshold is met, a confirmation may be sent to the repair center. If the threshold is not met, the system may wait on further responses from and/or transmit the damage estimate to other repair centers. The system may indicate whether one or more repair centers accepted one or more line-items in a record associated with the one or more damage elements in the damage estimate database. The system may adjust prices based on the records. For example, the system may increase the line-item cost estimates if too many repair centers are refusing to repair vehicles at the given costs in a region.

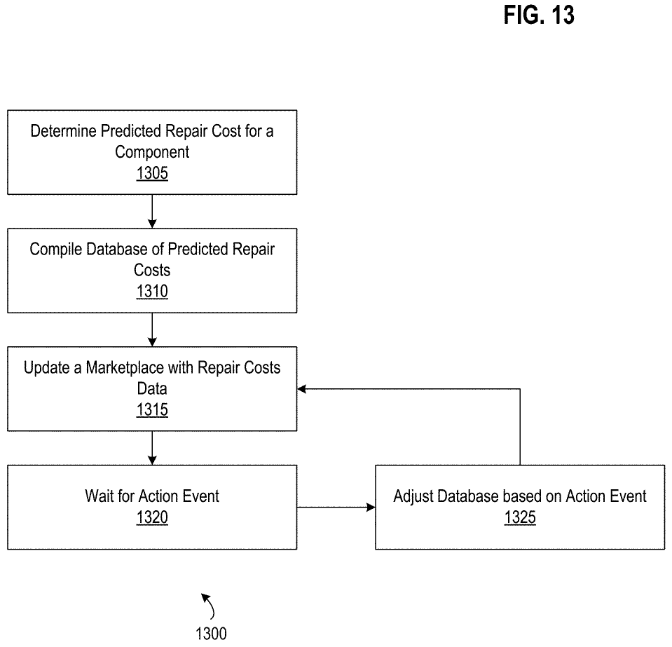

FIG. 13 depicts a method for determining a value associated with a predicted future damage estimate for a vehicle. The value (e.g., an estimate of probable damage to the vehicle) may present a consumer or marketplace consumer with a readily identifiable value corresponding to the risk of future claims (and/or associated costs) for a vehicle.

At step 1305, the damage estimate processing server may determine a predicted repair cost for a component. Estimated repair costs may be determined based on analyzing damage to a vehicle and tracking costs for repair. For example, a damage estimate may be prepared according to one or more methods described herein (e.g., a damage estimate may be prepared in block 1130). The damage estimate may be stored in a database of the damage estimate processing server. In some instances, actual repair costs (e.g., repair costs received from a service center) may be used instead of an estimate.

At step 1310, the damage estimate processing server may compile a database of predicted repair costs for components. The database may correlate multiple factors. For example, the database may identify a damage type (e.g., hail, collision, scratch, etc.), a damage location (e.g., fender, door, roof, etc.), a location (e.g., location of the accident, home of the policy holder, etc.), a vehicle type (e.g., make and/or model of the vehicle), and/or any such value as may prove useful in determining, searching and/or predicting repair costs. In some instances, a line-item cost estimate as described herein may be used as a source of damage information and/or repair cost information for a vehicle.

At step 1315, the damage estimate processing server may update a marketplace with the estimated repair costs from the database. Repair cost information (e.g., database values and/or the information from which the database values are derived) may be a valuable tool for determining the risk of repair costs for a vehicle. The database may store damage items, repair costs, and/or calculated values based on other data (e.g., predicted repair costs). For example, the database may indicate that 38% of insured vehicles in Georgia have had hail damage in the past 5 years, and so there is a 48% chance of hail damage to a vehicle in Georgia that is not stored in a garage in the next 3 years.

A marketplace may be established for buying and selling risk information. For instance, an insurance marketplace may allow insurance providers to access risk information from the database. Insurance providers and/or underwriters may determine rates for insurance policies based on the information. For example, an insurance provider may offer an insurance policy to the consumer that protects against hail damage for a vehicle in Ohio. The insurance provider may reference the database to determine the predicted repair costs for hail damage for a make and model vehicle in Ohio corresponding to the vehicle to be insured.

In some instances, telematics information may be stored in the database and/or published on the marketplace. The telematics information may provide vehicle operation data associated with a vehicle. In some instances, the telematics information may associate a driver with the information. For example, the telematics information may indicate the instances of speeding, hard braking, hard turns, or other such information associated with individual drivers. In other instances, the information may be anonymized (such as by removing private information). For example, the telematics information may indicate aggregated driving statistics for drivers of a certain make and model of car without providing personal information (name, age, etc.) for the drivers. This may allow insurance providers to calculate tailored insurance rates for vehicles based on telematics information collected in real-time from actual drivers without compromising driver privacy.

Premiums and/or deductibles for insurance policies may be established based on the database information and/or value(s) associated with customer data. For example, a consumer with a vehicle with high predicted repair costs may be charged a higher premium than a consumer with low predicted repair costs.

In some instances, the risk information may be collected to determine predicted repair costs for a class of consumer. Over time, the damage estimate processing server may determine the behavioral patterns based on detecting associations between different data points known to the damage estimate processing server. For example, the damage estimate processing server may determine that individuals with more than two broken window repairs have a 43% chance of vehicle theft, while individuals with two or less broken window repairs have a 21% chance of vehicle theft. The damage estimate processing server may continually iterate on this information to determine more and/or more accurate associations and/or patterns. For example, using data collected over time, the damage estimate processing server may determine that individuals with a child are 15% less likely to suffer hail damage because are more likely to own a home with a garage. Thus, the damage estimate processing server may determine a decreased chance of hail damage (and a lower associated predicted repair cost) for families with a child.

In some instances, the determined, resultant behavioral data representing the behavioral patterns and/or the data used to determine behavioral patterns may be made available through the marketplace. A database of patterns may be made available detailing the risks associated with given behaviors (e.g., predicted repair costs based on consumer demographics). An insurer may pay to have access to a marketplace of the data in order to better tailor insurance products for a consumer based on associated predicted repair costs. For example, the insurer may increase premiums for all customers by 7% because the data used to determine behavioral patterns indicates an overall 7% increase in predicted repair costs. In some instances, a governmental entity, such as the Department of Transportation, may subscribe to the marketplace in order to determine how best to predict, identify, and/or react to consumer risks. Data may also be used for advertising purposes. An advertiser may use the data to associate online activity with demographic information for targeted advertising. For example, an automotive manufacturer may determine a demographic of consumers who likely drive in congested areas for a directed advertising campaign regarding fuel-efficient vehicles. In another example, service centers approved by the insurance provider might provide targeted advertising for consumers (e.g., advertisements for vehicle inspections from trusted repair centers that may reduce the likelihood for future claims).

In some instances, access to the marketplace may be restricted and/or incur a fee. For example, a fee may be charged to access risk information collected by the damage estimate processing server. In some instances, the damage estimate processing server may collect information from a variety of sources (e.g., accident reports, repair center bills, user accounts, invoices, vehicle operation data, etc.), and store the combined information in a database. In some instances, a separate fee may be charged for access to only a subset of the database information. In some instances, private information may be removed from data published to the marketplace. For example, damage information for a vehicle may indicate the owner of the vehicle, policy number, claim number for the damage, etc. Such private information may be anonymized such that a service provider who buys the information on the marketplace may not obtain sensitive and/or private information corresponding to a consumer. This may allow a service provider to efficiently tailor services using information from real incidents without compromising customer privacy.

In some instances, future transactions may be modified based on information published on the marketplace. Service centers may be certified for repairs. For example, a service center that conforms to certain practices may be a “certified” repair center. As a certified provider, damage information indicating what repairs have been conducted may be published for vehicles that the service center repairs. Future work on the vehicle may be evaluated to determine if the work was completed properly. If the repairs were not conducted, were conducted improperly, and/or were insufficient to prevent future damage, this may be noted. If the failures reach a certain threshold (e.g., a failure rate falls below a threshold according to an algorithm), the repair center may then lose their “certified” status as a result of their failure to properly repair the vehicle.

Vehicle sales may also utilize damage information published in the marketplace. The published information may provide a high level of detail regarding damage done to a vehicle and any repairs that were undergone to fix the damage. A customer may consult this information in order to help determine a proper evaluation of a vehicle for purchase. For example, a damage estimate processing server may determine a correlation between prior damage to a vehicle and the probability of future damage and/or repairs for a new owner. Based on this information, the damage estimate processing server may determine an estimated amount of future repairs that are likely to be required by the vehicle. The damage estimate processing server may further determine a value of the vehicle based on a standard value (e.g., a bluebook value of a car) adjusted by the estimated amount of future repairs.

At step 1320, the damage estimate processing server may determine if an action event has been detected. An action event may comprise a change in status or information associated with a vehicle and/or insured. For example, the damage estimate processing server may detect that an insured has moved to a new region in a state associated with more hail damage. In another instance, the damage estimate processing server may detect that a vehicle has undergone repair work as a result of a collision.

At step 1325, the damage estimate processing server adjusts the database based on the action event. For example, if the damage estimate processing server is informed that a vehicle is involved in a rear-end collision, the damage estimate processing server may increase the predicted repair costs for the vehicle (e.g., a collision may increase the chance of latent damage that may increase later repair costs). In yet another example, the database may be adjusted to notate a new geographic area associated with an insured. After adjusting the value, the damage estimate processing server may return to step 1315 to update the marketplace with the new risk information.

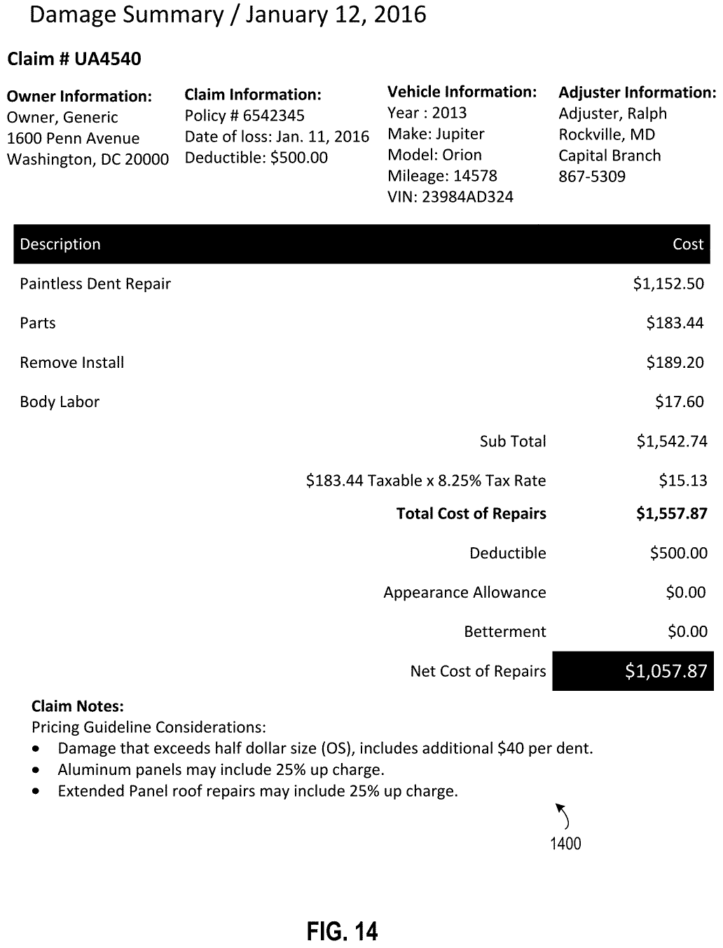

FIG. 14 depicts an exemplary description in a damage summary corresponding to a vehicle. A damage summary may indicate repair costs for damage incurred to a vehicle, such as one or more damage estimates determined by a damage estimate processing server. The damage summary may provide information associated with a claim, a description of repair costs, a breakdown of repair costs, one or more locations to be repaired, and/or other such information. A repair center may consider the damage summary in determining whether or not to conduct repairs.

The damage summary may indicate general information associated with a claim. For example, the damage summary may present a claim number, owner information (e.g., name, address, date of birth, etc.), claim information (e.g., policy number, date of loss, deductible, etc.), vehicle information (e.g., make, model, year, mileage, vehicle identification number (VIN), etc.) and/or adjuster information (e.g., agent name, location, associated branch, etc.).

The damage summary may present a description of repairs associated with a vehicle. In some instances, the description may present cost categories. For example, the description may list costs for paintless dent repair, parts, removal of parts as required for install, and labor to repair the car body. In some instances, the description may present a line-item repair estimate. For example, the damage summary may present a list of instances of hail damage along with other details corresponding to each instance (e.g., size, depth, location on the vehicle, price to repair, etc.). In some instances, the description may comprise a non-negotiable amount to be paid to a repair center in order to have damage repaired (such as described in FIG. 12). For example, the repair center may receive a damage summary, review the listed net cost of repairs, determine to conduct repairs using the listed amount, and perform the listed repairs. The repair center may then determine profits based off the net cost of repairs provided by damage summary and the cost incurred to the repair center to conduct the repairs.

The damage summary may also comprise additional notes. The notes may indicate special attention to be given to the vehicle, damage not to be repaired, additional allowed charges, or other such information. For example, the notes may indicate that hail damage over a certain size may allow an additional fee, that the removal of aluminum panels may allow an additional fee, and that extended panel roof repairs may allow an additional fee. This may allow a repair center to adjust costs according to noted issues that may complicate a repair.

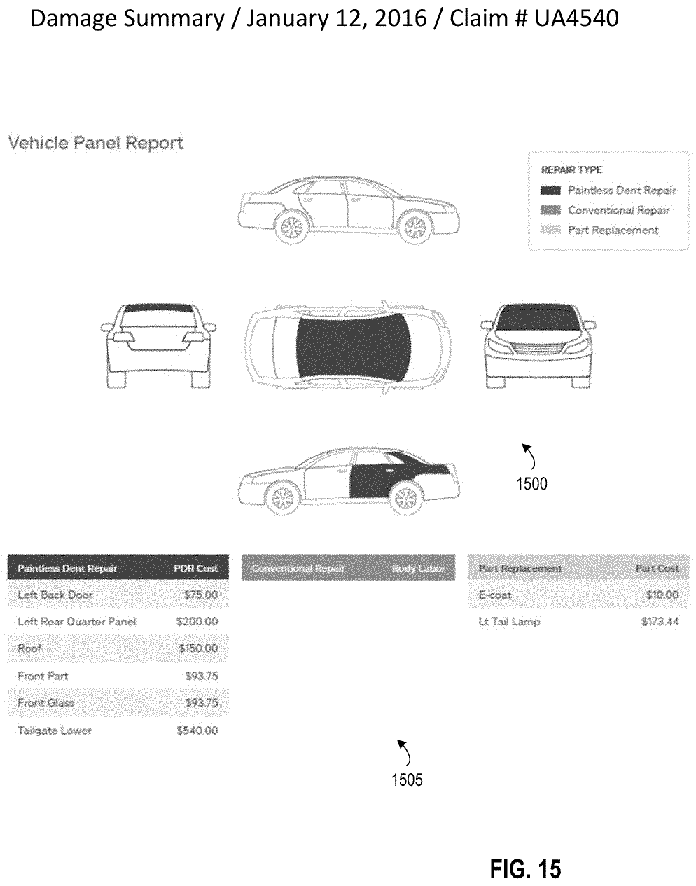

FIG. 15 depicts an exemplary vehicle panel report for a damage summary. The vehicle damage report may provide a breakdown of repair costs based on areas of a vehicle. For example, the vehicle panel report may indicate that a left back door has $75 in repairs, a left rear quarter panel has $200 in repairs, a roof has $150 in repairs, a front part has $93.75 in repairs, a front windshield has $93.75 in repairs, and a lower tailgate has $540 in repairs.

The vehicle panel report may indicate other repair items to be performed. For example, the vehicle panel report may indicate conventional repairs to be conducted as part of a claim(e.g., replacing a fender, replacing a muffler, patching a tire, repairing an engine, etc.).

The vehicle panel report may also indicate parts to be replaced. A price to be paid to a repair center in exchange for replacing the part may be listed. For example, a repair cost of $10 for an E-coat and $173.44 for a tail lamp may be given. In some instances, the repair center would be provided those funds if they replaced the part, regardless of the actual cost of the part.

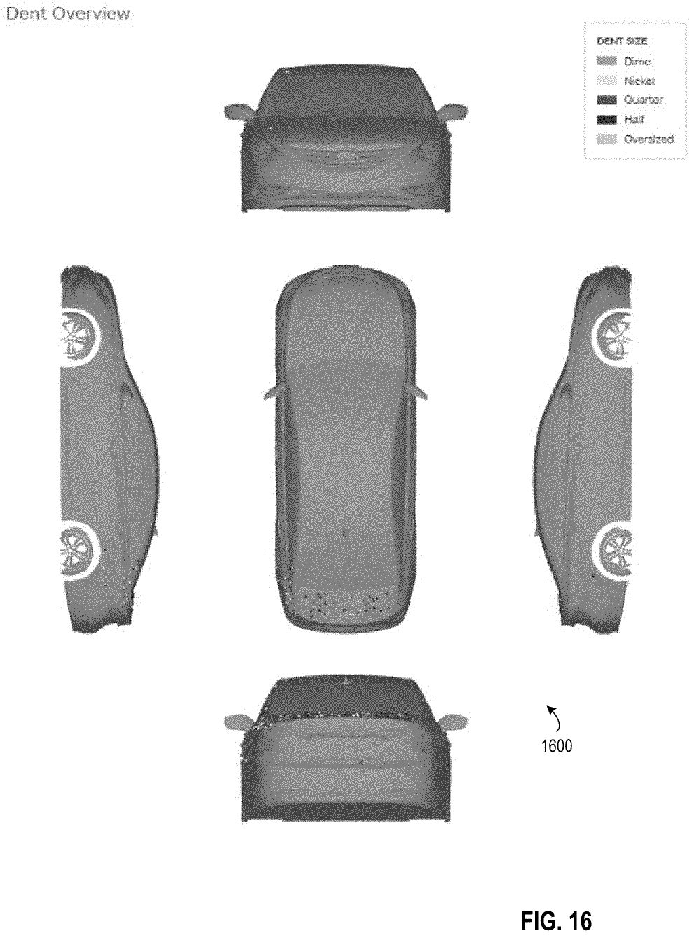

FIG. 16 depicts an exemplary dent overview for a damage summary. A device, such as an enhanced claims processing apparatus 400, may determine one or more instances of hail damage on a vehicle corresponding to a damage summary. The locations of the hail damage may be indicated on a rendering of the vehicle, along with other information (such as size, depth, etc.). Further description of providing information regarding hail damage to be repaired may be found in FIG. 13.

Aspects of the disclosure have been described in terms of illustrative embodiments thereof. Numerous other embodiments, modifications, and variations will occur to persons of ordinary skill in the art from a review of this disclosure. For example, one of ordinary skill in the art will appreciate that the steps discussed herein may be performed in other than the recited order, and that one or more steps may be optional in accordance with aspects of the disclosure.

1. A computer-implemented method comprising:
receiving, at an enhanced claims processing server and from a telematics device structured to automatically transmit telematics data to the enhanced claims processing server, the telematics data, wherein the telematics device comprises an impact sensor, and wherein the telematics data comprises at least one of:
one or more impact parameters associated with a vehicle, the one or more impact parameters detected by the impact sensor,
identifying information for the vehicle, and
additional information for the vehicle captured within a time range of the one or more impact parameters, the additional information comprising at least one of a speed and an acceleration of the vehicle prior to detecting the one or more impact parameters by the telematics device;
determining, by a telematics analyzer of the enhanced claims processing server and based on analyzing the telematics data, that the vehicle is a damaged vehicle;
determining, by the telematics analyzer of the enhanced claims processing server, and responsive to determining that the vehicle is damaged, a notice of loss associated with the damaged vehicle;
receiving damage information at the enhanced claims processing server and analyzing the damage information by a damage information analyzer, wherein the damage information comprises one or more pre-stored images received from a damaged item image data store;
determining, responsive to analyzing the damage information, one or more characteristics of one or more damage elements, the one or more characteristics comprising at least one of a depth, a diameter, or a severity of a corresponding damage element;
determining, by one or both of 1) the telematics analyzer based on the telematics data and 2) the damage information analyzer based on an aggregate of the one or more damage elements, that a part of the damaged vehicle needs to be replaced and one or more physical parts needed to repair the damaged vehicle;
transmitting, by the enhanced claims processing server, the damage information and the additional information to a damage estimate processing server;
determining, by the damage estimate processing server and based on damage information, the additional information, and the telematics data, a predicted repair cost for the damaged vehicle, the one or more damage estimates determined based on analyzing:
the damage information relative to the identifying information and the additional information supplied by the telematics device; and
the one or more pre-stored images relative to repair cost data associated with the one or more pre-stored images;
receiving captured images of actual damage to the damaged vehicle and metadata associated with the captured images, the metadata indicative of an actual repair cost corresponding to the actual damage;
updating the damaged item image data store with the captured images and the metadata;
generating, by the damage estimate processing server, a damage summary comprising:
an indication that the part of the damaged vehicle needs to be replaced,
an indication of the one or more physical parts and a price associated with each of the one or more physical parts, and
a list of the one or more damage elements, the list of the one or more damage elements comprising the one or more characteristics;
storing, by the damage estimate processing server, and in a database, the predicted repair cost and the additional information, wherein the additional information is anonymized;
publishing, by the enhanced claims processing server, the database to a marketplace;
receiving, by the enhanced claims processing server and from a repair center, an indication that the repair center refuses to conduct repairs according to the predicted repair cost;
increasing, by the enhanced claims processing server, the predicted repair cost based on the refusal; and
updating, by the enhanced claims processing server, an entry for the predicted repair cost in the database published to the marketplace.

2. The method of claim 1, wherein the damage information comprises hail damage information received from a depth sensor, and wherein the hail damage information comprises a dimension of an instance of hail damage, a rating of the instance of hail damage, and an image of the instance of hail damage.

3. The method of claim 2, wherein the damage information further comprises notes identifying unrepaired damage associated with the damaged vehicle.

4. The method of claim 2, wherein the determining the predicted repair cost comprises:
determining the damage information associated with a claim corresponding to the damaged vehicle;
determining a plurality of entries in the database corresponding to the damage information;
determining a cost estimate based on the plurality of entries; and
determining the predicted repair cost based on the cost estimate.

5. The method of claim 4, wherein the damage information comprises a list of vehicles to be repaired, a cost corresponding to the list of vehicles to be repaired, and a plurality of photos corresponding to the list of vehicles to be repaired.

6. The method of claim 1, further comprising:
transmitting a request to repair a damaged vehicles comprising a line-item cost estimate based on the predicted repair cost to the repair center; and
further comprising receiving, by the enhanced claims processing server, a response to the request.

7.-8. (canceled)

9. A system comprising:
one or more processors;
a damage information data store that stores:
damage information describing a plurality of damage elements associated with a damaged vehicle, the damage information comprising one or more pre-stored images, and
telematics information associated with a vehicle, wherein the telematics information is anonymized;
a repair cost data store that stores a repair cost matrix corresponding to a various types and characteristics for each of the plurality of damage elements;
a telematics device comprising an impact sensor, the telematics device configured to:
monitor the telematics information comprising one or more impact parameters and additional information associated with the vehicle, the one or more impact parameters detected by the impact sensor, and the additional information comprising at least one of a speed and an acceleration of the vehicle prior to detecting the one or more impact parameters by the impact sensor, and
automatically transmit the telematics information to the damage information data store; and
memory storing instructions that are executed by at least one of the processors and cause the system to:
receive, from the telematics device, the telematics information;
determine, by a telematics analyzer and based on analyzing the telematics information, that the vehicle is the damaged vehicle;
determine, by the telematics analyzer and responsive to determining that the vehicle is damaged, a notice of loss associated with the damaged vehicle;
analyze the damage information by a damage information analyzer;
determine, by the damage information analyzer and responsive to analyzing the damage information, one or more characteristics of one or more damage elements, the one or more characteristics comprising at least one of a depth, a diameter, or a severity of a corresponding damage element;
determine, by one or both of 1) the telematics analyzer and based on the telematics information and 2) the damage information analyzer based on an aggregate of the damage elements, that a part of the damage vehicle needs to be replaced and one or more physical parts needed to repair the damaged vehicle;
determine, based on the damage information, the additional information, and the telematics information, one or more damage estimates for each of the plurality of damage elements, the one or more damage estimates determined based on analyzing:
the damage information relative to the vehicle damage information, and the additional information supplied by the telematics device; and
the one or more pre-stored images relative to repair cost data associated with the one or more pre-stored images;
receive captured images of actual damage to the damaged vehicle and metadata associated with the captured images, the metadata indicative of an actual repair cost corresponding to the actual damage;
updating the damage information data store with the captured images and the metadata such that the captured images are included in the one or more pre-stored images and the metadata is included in the repair cost data associated with the one or more pre-stored images;
generate a damage summary comprising:
an indication that the part of the damaged vehicle needs to be replaced,
an indication of the one or more physical parts and a price associated with each of the one or more physical parts, and
a list of the one or more damage elements, the list of the one or more damage elements comprising the one or more characteristics;
publish the one or more damage estimates to a marketplace;
receive, from a repair service provider system associated with a repair service provider, feedback comprising an actual cost to repair the damaged vehicle;
update the one or more damage estimates based on the feedback received;
publish the updated one or more damage estimates to the marketplace;
receive, from a repair center, an indication that the repair center refuses to conduct repairs according to the one or more damage estimates;
increase the one or more damage estimates based on the refusal;
store the increased one or more damage estimates in the repair cost data store; and
publish an update to the marketplace comprising the increased one or more damage estimates.

10. The system of claim 9, wherein the damage information comprises hail damage information received from a depth sensor, and wherein the hail damage information comprises a dimension of an instance of hail damage, a rating of the instance of hail damage, and an image of the instance of hail damage.

11. (canceled)

12. The system of claim 9, wherein the determining the one or more damage estimates for each of the plurality of damage elements comprises:
determining the damage information associated with a claim corresponding to the damaged vehicle;
determining database entries for each of the plurality of damage elements corresponding to the damage information; and
determining the one or more damage estimates based on the database entries.

13. The system of claim 12, wherein the one or more damage estimates comprise a list of vehicles to be repaired, a cost corresponding to the list of vehicles to be repaired and a plurality of photos corresponding to the list of vehicles to be repaired.

14. The system of claim 9, wherein the instructions are executed by at least one of the processors and further cause the system to:
transmit a request to repair the damaged vehicle comprising a line-item cost estimate based on the one or more damage estimates to the repair center; and
receive a response to the request.

15. (canceled)

16. The system of claim 9, wherein the instructions are executed by at least one of the processors and further cause the system to:
remove private information from the one or more damage estimates prior to publishing the one or more damage estimates to the marketplace.

17. A computer-implemented method of processing insurance claims comprising:
receiving, at an enhanced claims processing server and from a telematics device structured to automatically transmit telematics data, the telematics data, wherein the telematics device comprises an impact sensor, and wherein the telematics data comprises at least one of:
one or more impact parameters associated with a vehicle, the one or more impact parameters detected by the impact sensor,
identifying information for the vehicle, and
additional information for the vehicle captured within a time range of the one or more impact parameters, the additional information comprising at least one of a speed and an acceleration of the vehicle prior to detecting the one or more impact parameters by the telematics device;
determining, by a telematics analyzer of the enhanced claims processing server and based on analyzing the telematics data, that the vehicle is a damaged vehicle;
determining, by the telematics analyzer of the enhanced claims processing server, and responsive to determining that the vehicle is damaged, a notice of loss associated with the damaged vehicle;
receiving damage information at the enhanced claims processing server and analyzing the damage information by a damage information analyzer, wherein the damage information comprises one or more pre-stored images received from a damaged item image data store;
determining, by the damage information analyzer and responsive to analyzing the damage information, one or more characteristics of one or more damage elements, the one or more characteristics comprising at least one of a depth, a diameter, or a severity of a corresponding damage element;
determining, by one or both of 1) the telematics analyzer based on the telematics data and 2) the damage information analyzer based on an aggregate of the one or more damage elements, that a part of the damaged vehicle needs to be replaced and one or more physical parts needed to repair the damaged vehicle;
transmitting, by the enhanced claims processing server, a request to repair the damaged vehicle to a repair center and a damage summary comprising:
an indication that the part of the damaged vehicle needs to be replaced,
a list of the one or more damage elements, the list of the one or more damage elements comprising the one or more characteristics,
an indication of the one or more physical parts, and
a price associated with each of the one or more physical parts, wherein the request comprises a damage estimate based on the damage information, the additional information, and the telematics data, wherein the damage estimate is determined based on analyzing:
the damage information relative to the identifying information and the additional information supplied by the telematics device; and
the one or more pre-stored images relative to repair cost data associated with the one or more pre-stored images;
receiving captured images of actual damage to the damaged vehicle and metadata associated with the captured images, the metadata indicative of an actual repair cost corresponding to the actual damage;
updating the damaged item image data store with the captured images and the metadata such that the captured images are included in the one or more pre-stored images and the metadata is included in the repair cost data associated with the one or more pre-stored images;
receiving, by the enhanced claims processing server, a response indicating that the repair center refuses to conduct repairs according to the damage estimate;
increasing, by the enhanced claims processing server and based on the response indicating the refusal, a predicted repair cost for the damage information;
storing, by the enhanced claims processing server, the predicted repair cost in a database; and
publishing, by the enhanced claims processing server, the database to a marketplace.

18. The method of claim 17, further comprising:
removing, by the enhanced claims processing server, private information from the database prior to publishing the predicted repair cost to the marketplace.

19. The method of claim 17, wherein the damage estimate comprises a list of vehicles to be repaired, a cost corresponding to the list of vehicles to be repaired and a plurality of photos corresponding to the list of vehicles to be repaired.

20. (canceled)

21. The method of claim 17, wherein the damage information comprises hail damage information received from a depth sensor, and wherein the hail damage information comprises a dimension of an instance of hail damage, a rating of the instance of hail damage, and an image of the instance of hail damage.

22. The method of claim 17, wherein the damage information further comprises notes identifying unrepaired damage associated with the damaged vehicle.

23. The method of claim 1, wherein the additional information comprises breaking information, and wherein the time range comprises a time range around a detected impact.

24. The system of claim 9, wherein the additional information comprises breaking information detected within a time range of detecting the one or more impact parameters by the impact sensor.

25. The method of claim 17, wherein the additional information comprises breaking information, and wherein the time range comprises a time range around a detected impact.

26. The method of claim 1, further comprising transmitting, by the enhanced claims processing server, a parts order comprising the one or more physical parts needed to repair the damaged vehicle and an indication of a recipient for the parts order, the recipient including at least one of a service provider and a local distribution center located in a geographic region were the damaged item will be repaired.
